(19) United States
(12) Patent Application Publication
(10) Pub. No.: US 2025/0279497 A1
(43) Pub. Date: Sep. 4, 2025

(54) SYSTEMS AND METHODS FOR IMPROVED SPATIAL COMPUTING SYSTEMS

(71) Applicant: Meta Platforms Technologies, LLC, Menlo Park, CA (US)

(72) Inventors: Ran Oliver Fang, Mountain View, CA (US); Yang Wang, San Jose, CA (US); Sergey Anatolyevich Babkin, Woodinville, WA (US); Jonathan Maloney-Lebensold, Outremont (CA); Maziar Sanjabi Boroujeni, San Francisco, CA (US); Pietro Astolfi, Montreal (CA); Adriana Romero Soriano, Montreal (CA); Kamalika Chaudhuri, San Diego, CA (US); Michael Gabriel Rabbat, Montreal (CA); Chuan Guo, San Francisco, CA (US); Christopher James Goodman, Round Rock, TX (US); Eric Griffith, Houston, TX (US)

(21) Appl. No.: 18/979,724

(22) Filed: Dec. 13, 2024

Related U.S. Application Data
(60) Provisional application No. 63/560,955, filed on Mar. 4, 2024.
(60) Provisional application No. 63/567,132, filed on Mar. 19, 2024.
(60) Provisional application No. 63/566,823, filed on Mar. 18, 2024.
(60) Provisional application No. 63/671,294, filed on Jul. 15, 2024.
(60) Provisional application No. 63/687,888, filed on Aug. 28, 2024.

(51) Int. Cl. H01M 10/637; G06F 1/16; G06T 15/10; G06T 19/00; H01M 10/48; H01M 10/613; H01M 10/623; H01M 10/633; H02J 7/00

(52) U.S. Cl. CPC H01M 10/637; G06F 1/163; G06T 15/10; G06T 19/006; H01M 10/486; H01M 10/613; H01M 10/623; H01M 10/633; H01M 2220/30; H02J 7/00309

(57) ABSTRACT

A method for improved heat discharge may include sensing a temperature value of a battery circuit; activating a heat dissipation element within the battery circuit when the temperature value reaches a threshold; discharging heat from the battery circuit via the activated heat dissipation element; and deactivating the heat dissipation element when the temperature value falls below the threshold.

### CROSS-REFERENCE TO RELATED APPLICATIONS

This application claims priority to U.S. Application 63/560,955, filed 4 Mar. 2024, U.S. Application 63/567,132, filed 19 Mar. 2024, U.S. Application 63/566,823, filed 18 Mar. 2024, U.S. Application 63/671,294, filed 15 Jul. 2024, and U.S. Application 63/687,888, filed 28 Aug. 2024, the disclosures of each of which are incorporated, in their entirety, by this reference.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIG. 1 is an illustration of an example battery protection circuit according to some embodiments of this disclosure.

FIG. 2 is an illustration of an example battery protection device according to some embodiments of this disclosure.

FIG. 3 is an illustration of an exemplary head-mounted display that is configured to provide both a real-world view and a virtual world view to a user, according to some embodiments of this disclosure.

FIG. 4 is an illustration of an example differentially private retrieval-augmented diffusion model images, according to some embodiments of this disclosure.

FIG. 5 is an illustration of an example differentially private retrieval-augmented diffusion model pipeline, according to some embodiments of this disclosure.

FIG. 6 is an illustration of an example differentially private retrieval-augmented diffusion model retrieval pipeline, according to some embodiments of this disclosure.

FIG. 7 is an illustration of an example differentially private retrieval-augmented diffusion model Shutterstock samples, according to some embodiments of this disclosure.

FIG. 8 is an illustration of an example differentially private retrieval-augmented diffusion model samples, according to some embodiments of this disclosure.

FIG. 9 is an illustration of example adaptive tessellation quads, according to some embodiments of this disclosure.

FIG. 10 is an illustration of example 5-bit value quads, according to some embodiments of this disclosure.

FIG. 11 is an illustration of an example adaptive tessellation quads representing a z-surface, according to some embodiments of this disclosure.

FIG. 12 is an illustration of an example modified adaptive tessellation quads representing a z-surface, according to some embodiments of this disclosure.

FIG. 13 is an illustration of an example artificial-reality system according to some embodiments of this disclosure.

FIG. 14 is an illustration of an example artificial-reality system with a handheld device according to some embodiments of this disclosure.

FIG. 15A is an illustration of example user interactions within an artificial-reality system according to some embodiments of this disclosure.

FIG. 15B is an illustration of example user interactions within an artificial-reality system according to some embodiments of this disclosure.

FIG. 16A is an illustration of example user interactions within an artificial-reality system according to some embodiments of this disclosure.

FIG. 16B is an illustration of example user interactions within an artificial-reality system according to some embodiments of this disclosure.

FIG. 17 is an illustration of an example wrist-wearable device of an artificial-reality system according to some embodiments of this disclosure.

FIG. 18 is an illustration of an example wearable artificial-reality system according to some embodiments of this disclosure.

FIG. 19 is an illustration of an example augmented-reality system according to some embodiments of this disclosure.

FIG. 20A is an illustration of an example virtual-reality system according to some embodiments of this disclosure.

FIG. 20B is an illustration of another perspective of the virtual-reality systems shown in FIG. 20A.

FIG. 21 is a block diagram showing system components of example artificial- and virtual-reality systems.

Throughout the appendices, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

### Systems and Methods for Improved Heat Discharge

The present disclosure is generally directed to systems and methods for actively discharging a smart glasses case when certain temperature thresholds are met to avoid thermal damage. The idea uses a combination of hardware and firmware to detect when the case is at or approaching high temperatures using a battery temperature sensor and then algorithmically determine when it should start to actively discharge. An active discharge circuit can be implemented using several metal-oxide-semiconductor field-effect transistors (MOSFETs) with general-purpose input/output (GPIO) control, each connected to a high-power resistor. These MOSFETs can be turned on independently to control how much current is being discharged. The total current can be up to hundreds of mA. Splitting up the circuit into multiple parallel resistors also spreads out the heat dissipation in the case to avoid a specific hotspot that could damage components or the user.

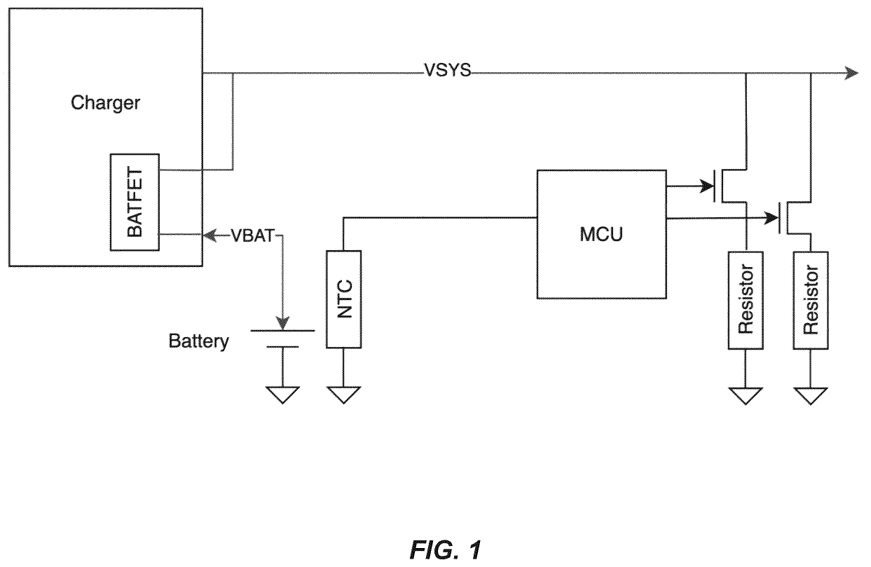

The disclosed systems and methods for improved heat discharge may include a microcontroller that may sense a temperature value of a battery circuit using a thermal sensor (e.g., negative temperature coefficient thermistor (NTC)). For examples, FIG. 1 shows an example battery protection circuit according to some embodiments of this disclosure. The thermal sensor may be built into a battery pack within the battery circuit. In some methods, the microcontroller may activate a heat dissipation element within the battery circuit when the temperature value reaches a predetermined threshold. The microcontroller may connect to an active discharge circuit including heat dissipation elements, which may include but are not limited to high-power resistors, GPIO control units, and MOSFETS. The microcontroller may have independent control over each high-power resistor via a GPIO control over a MOSFET. The MOSFETS may be turned on independently to control the amount of current that may be discharged from the battery. The active discharge circuit may be split up into multiple parallel resistors that may spread out the heat dissipation and avoid hot spots that may damage surrounding components within the battery circuit. In other methods, the microcontroller may discharge heat from the battery circuit via the activated heat dissipation elements. The microcontroller may predict via firmware (e.g., algorithm, prediction model, etc.) when it is optimal to discharge heat from the battery depending on a variety of conditions, including when the temperature value reaches the predetermined threshold and when the battery reaches a safe level of voltage. In further embodiments, the microcontroller may deactivate the heat dissipation element when the temperature value falls below the predetermined threshold.

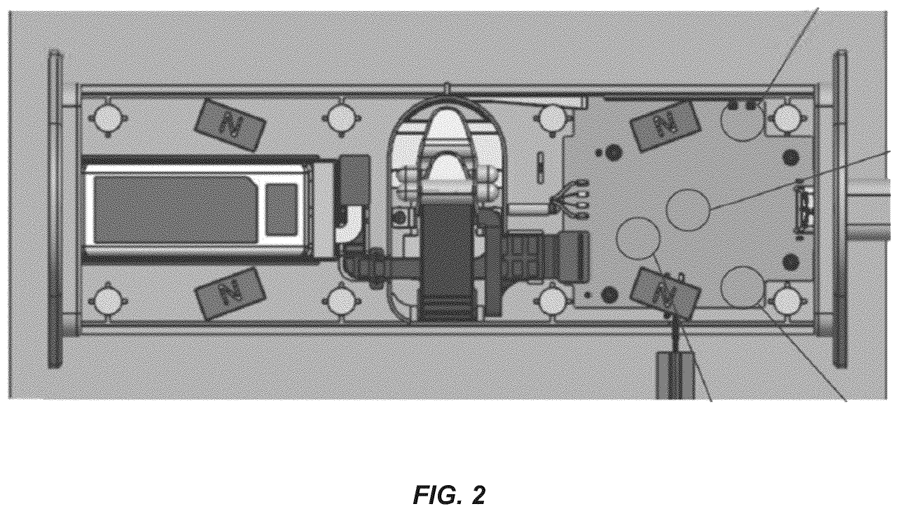

In some embodiments, the battery circuit may have various configurations and/or components. For example, FIG. 2 shows an example battery circuit according to some embodiments of this disclosure, including an active discharge circuit. In some examples, the active discharge circuit and additional components (including, e.g., an integrated circuit) may be spatially positioned away from the battery to minimize risk of thermal damage to key components and the battery.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

### Example Embodiments

Example 1: A method including (1) sensing a temperature value of a battery circuit; (2) activating a heat dissipation element within the battery circuit when the temperature value reaches a threshold; (3) discharging heat from the battery circuit via the activated heat dissipation element; and (4) deactivating the heat dissipation element when the temperature value falls below the threshold.

### Bifocal AR/VR Headset for Business Use

Virtual-reality (VR) devices, augmented reality devices, and other artificial reality devices (collectively referred to as artificial-reality devices) can provide a rich, immersive, experience that enables users to interact with virtual objects and/or real objects that have been virtually augmented in some fashion. While artificial-reality devices are often utilized for gaming and other entertainment purposes, they are also commonly employed for purposes outside of recreation. For example, governments may use them for military training simulation, doctors may use them to practice surgery, and engineers may use them as visualization aids.

One example of an artificial-reality device is a head-mounted display (HMD) that fully immerses a user in a VR or other alternate reality experience. Conventional HMDs like this typically include a display housing that, when worn, prevents light from the user's external environment from entering the display housing, and thus, the user's field of view. While such a configuration may enhance the user's VR experience, this housing also prevents the user from viewing the real-world environment, which may make it difficult for the user to interact with real-world objects (including objects that are displayed and/or augmented in some fashion in VR). For example, a user sitting at a desk and wearing an HMD may find it difficult to operate a computer keyboard, a mouse, a stylus, or the like since the HMD (and, in particular, the HMD's display housing) blocks the user's view of such objects.

The present disclosure is generally directed to an HMD device configured to provide a user with a substantially unobstructed view, through a bottom portion of the device's housing, of the user's real-world environment. As will be explained in greater detail below, an HMD device may include (1) a display unit configured to display computer-generated imagery to a user and (2) a housing that retains the display unit. The HMD device may be mounted on the user's head and the display unit may be positioned in a top portion of a field of view of the user. The display unit may be dimensioned to provide the user with a substantially unobstructed bottom view of the field of view of a real-world environment to the user.

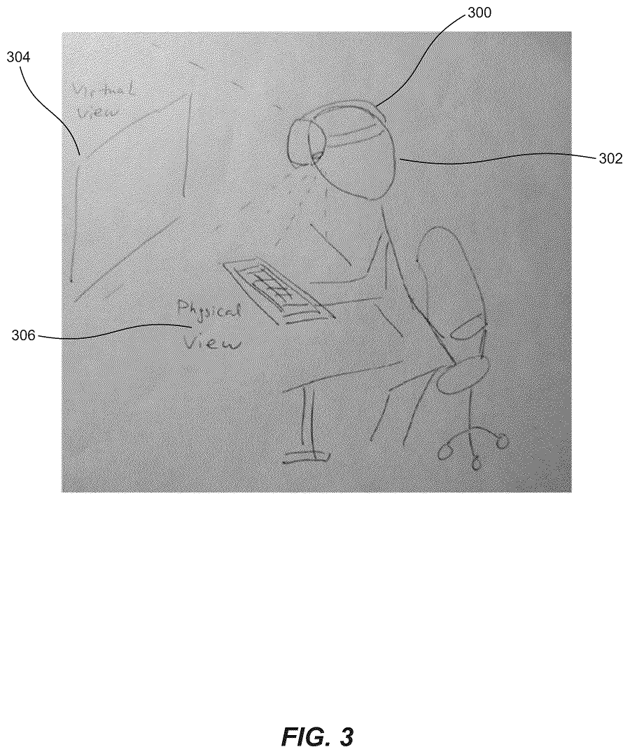

Features from any of the embodiments described herein may be used in combination with one another in accordance with the general principles described herein. These and other embodiments, features, and advantages will be more fully understood upon reading the following detailed description in conjunction with the accompanying drawings and claims. The following will provide, with reference to FIG. 3, detailed descriptions of an HMD device worn by a user configured to provide a real-world view and a virtual world view.

Turning to FIG. 3, exemplary HMD device 300 may both present a real-world view 106 and a virtual world view 304 to a user 302. As used herein, an HMD device may generally refer to a device that is used to operate in a VR environment, an augmented reality environment, a mixed reality environment, or some combination thereof. HMD device 300 may present a variety of content to a user, including virtual views of an artificially rendered virtual-world view 304 and/or augmented view of real-world view 306. HMD device 300 may include a display unit configured to display computer-generated imagery to user 302 and a housing that retains the display unit.

As illustrated in FIG. 3, HMD device 300 may be adapted to combine real-world view 306 and virtual world view 304 for user 302. For example, HMD device 300 may be mounted on a head of user 302 such that the display unit, which may be configured to display a virtual world view 304, is positioned in a top portion of the field of view of the user 302. While the display unit may obstruct the top portion of the field of view of the user 302, the housing of HMD device 300 may be dimensioned to provide the user with a substantially unobstructed bottom portion of the field of view of the real-world view 306 to the user 302. In some embodiments, HMD device 300 may completely obstruct the user's view of the real world 306. In other embodiments, HMD device 300 may only partially obstruct the user's view of the real world 306 and/or may obstruct the field of view of user 302 depending on content being displayed on the display unit of HMD device 300.

In some embodiments, an alternative face cushion (not shown in drawings) that defines an opening around a nose area of user 302 may be used to provide an unobstructed view of the real-world view 306 to the user 302. In some embodiments, lenses within the HMD device 300 may be shifted (relative to traditional orientations) since the eyes of user 302 will be located lower relative to the display unit. In addition, software may be modified to center virtual images generated by the display unit at a new, raised height since the display housing will not cover the entire field of view of user 302.

Because HMD device 300 may be adapted to provide a user with both real-world view 306 and virtual world view 304, HMD device 300 may obviate the need for virtual keyboards and/or other artifacts that may be unsuitable for practical use. For example, the exemplary HMD configuration described and illustrated herein may enable a user to quickly and seamlessly interact with both real-world objects (e.g., physical keyboards) and virtual objects (displayed, e.g., on a display unit of an HMD) without having to don or doff the HMD to do so.

### Example Embodiments

Example 2: A head-mounted display including (i) a display unit configured to display computer-generated imagery to a user and (ii) a housing that retains the display unit, where, when the head-mounted display is mounted on a head of the user and the display unit is positioned in a top portion of a field of view of the user, the display unit obstructs the top portion of the field of view of the user and the housing is dimensioned to provide the user with a substantially unobstructed bottom portion of the field of view of a real-world environment to the user.

### Systems and Methods for Improved Diffusion Models

The present disclosure is generally directed to systems and methods for improved diffusion models that employ a novel technique to train a high-quality text-to-image generative model by using two sets of training data. This training data includes a “public” dataset of images for which no guarantee of privacy is provided, such as data that has been purchased or licensed with rights to reproduce, and a “private” dataset of images that the model should not memorize or be capable of reproducing exactly. At a high level, the present disclosure employs a novel way of combining differential privacy guarantees with retrieval-augmentation for image generation. This disclosure may also inherit all the benefits of retrieval-augmented generative models. Additionally, it may be possible to easily remove or add data from/to the retrieval database after the model has been trained, without needing to do any retraining. Further, this disclosure may negate the computational limitations of traditional differential privacy methods and may enable the use of large-scale, high-fidelity image generative models with differential privacy guarantee.

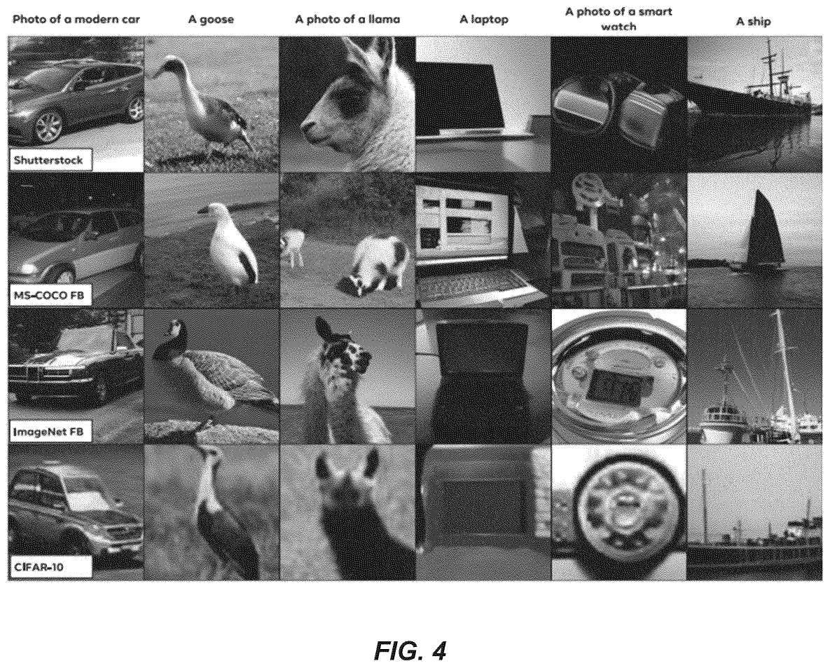

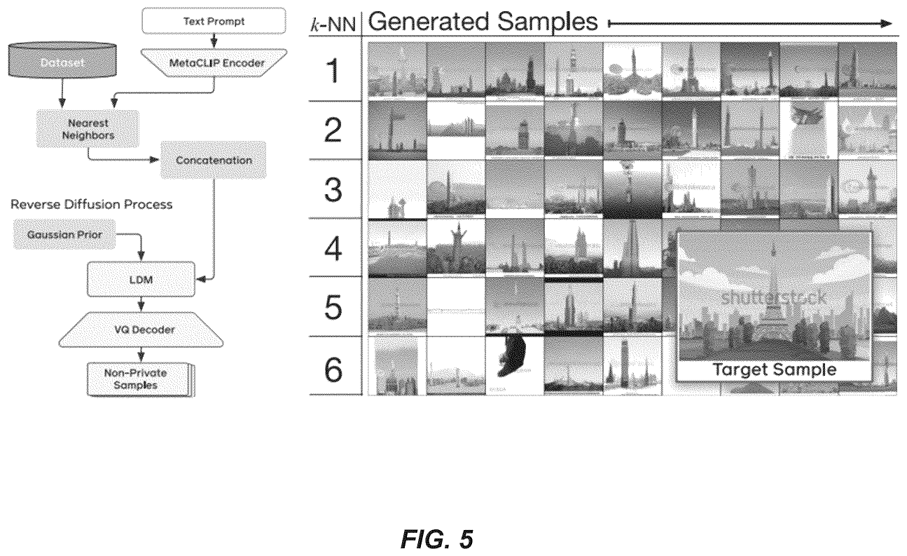

In one example, the disclosed systems and methods for improved diffusion models may include an architecture for a differentially private retrieval-augmented latent diffusion model (DP-RDM) for image generation. For example, FIG. 4 shows an example differentially private retrieval-augmented diffusion generated images. The diffusion model may include a process for retrieval augmentation that incorporates differential privacy. In other embodiments, differential privacy guarantees may be obtained for data used in the retrieval dataset at inference time, where the use of differentially private stochastic gradient descent (DP-SGD) for training may be avoided. In some methods, the retrieval augmentation mechanism may include retrieval dataset subsampling, where the model is presented with a new prompt to generate images. For example, FIG. 5 shows an example differentially private retrieval-augmented diffusion model pipeline for generating the images. The retrieval data set may include a subset that is randomly selected and considered for responses to the prompt.

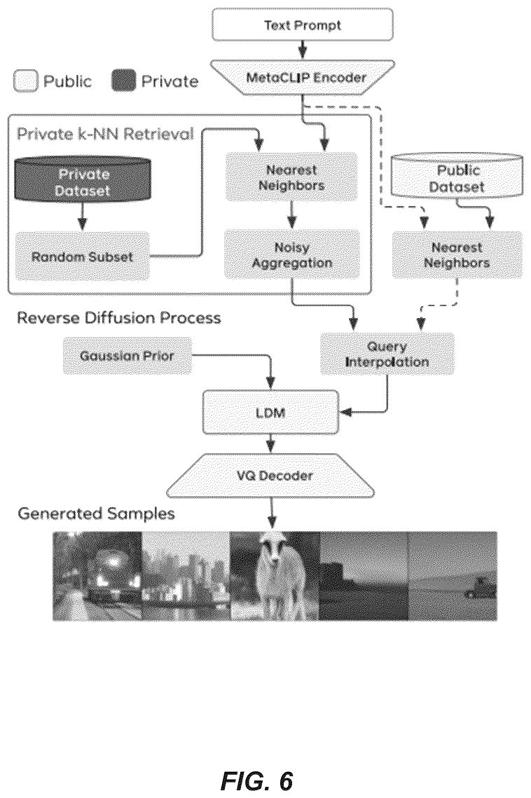

In some embodiments, the retrieval augmentation mechanism may include an aggregation method where the nearest neighbors (e.g., retrieval neighbors “k”) are selected among data sets (e.g., D and D′), where distance may be measured in an embedding space used by the model. For example, FIG. 6 shows an example differentially private retrieval-augmented diffusion model retrieval pipeline to apply the aggregation method. In further embodiments, the model may include a text encoder and an image encoder where the embedding spaces may be aligned. The prompt may be embedded using the text encoder, and the images in the retrieval dataset may be embedded via the image encoder. In some methods, after embedding a text prompt (e.g., user input), the nearest neighbors in the data sets may be retrieved and averaged.

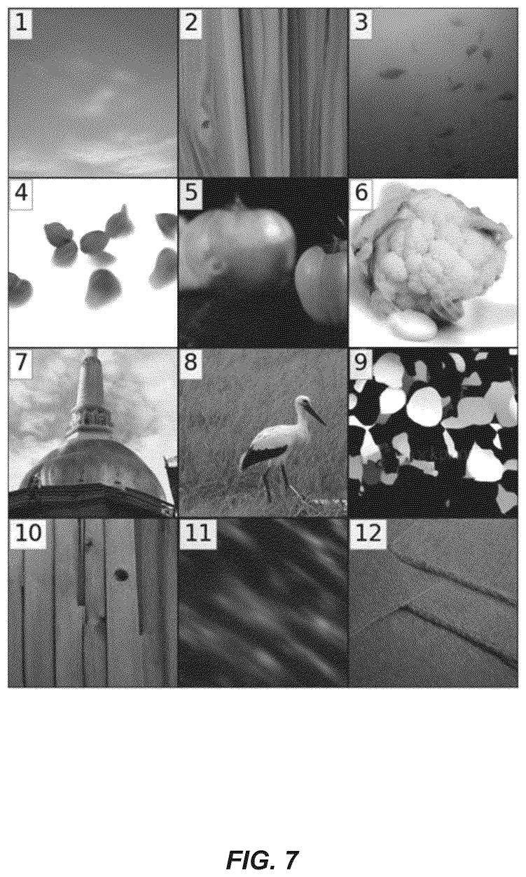

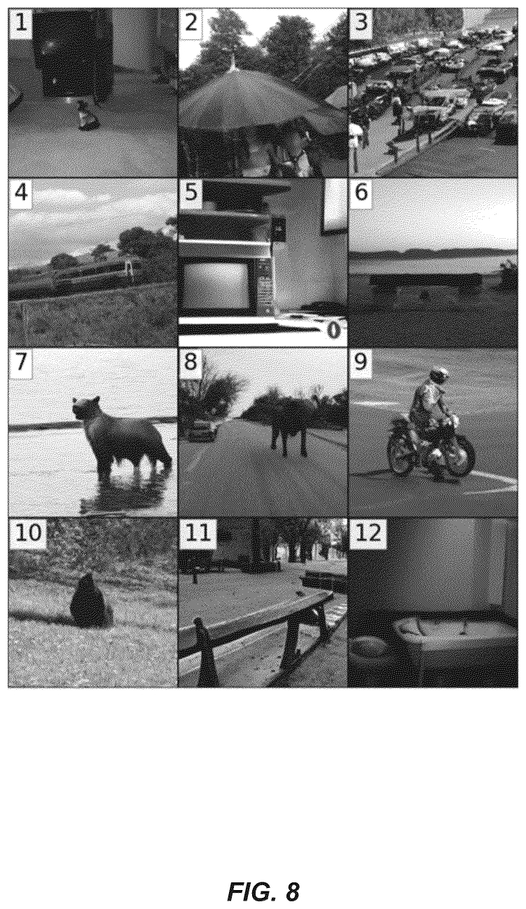

In some methods, Isotropic Gaussian noise may be added to the aggregated embedding. In other embodiments, the level of privacy guaranteed provided by adding Isotropic Gaussian noise may be adjusted by changing the subsampling ratio used (e.g., smaller ratio=more private), the number of nearest neighbors aggregated (e.g., more neighbors=more private), and the variance of the noise added (e.g., higher variance=more private). In other methods, the precise level of privacy protection may be quantified using privacy accounting frameworks (e.g., Renyi Differential Privacy and Gaussian Differential Privacy). In further methods, the model may be trained using a public dataset, both for updating the weights, and as the retrieval dataset. After the training is completed, a private dataset may be added to the retrieval dataset. The trained data sets may be instantiated and demonstrated for the retrieval-augmented diffusion model for generating images (e.g., generated images shown in FIG. 7 and FIG. 8). Additionally, the method may extend to models for generating text, further including multi-modal models (e.g., text+images, speech, music, audio, video, 3d meshes).

### Example Embodiments

Example 3: A computer-implemented method of augmenting image data, the method including: (1) retrieving a subset of image data from a private database in response to a user input; (2) privatizing the subset of image data; and (3) generating at least one image based on the privatized subset of image data and the user input.

### Systems and Methods for Adaptive Tessellation

The present disclosure is generally directed to a novel technique for adaptive tessellation that may convert a depth buffer into triangles that represent a z-surface. An algorithm may be used for converting a depth buffer into triangles. The algorithm may operate with a hardware implementation, where the algorithm operates inside a hardware unit (e.g., tile-based renderer) that may operate as a scene is being rendered. The algorithm may allow an error term to be specified which indirectly controls the number of triangles that are output. The algorithm may include two parts such as (1) deciding which depth values to ignore, and (2) computing the triangle topology for the depth values that are left. The hardware implementation inside the hardware unit may write out a data structure with each tile (e.g., 32×32 pixels), which may describe the triangles used to represent the z-surface. This data structure may be processed by software into a triangle list or may be processed directly by the hardware in some implementations. This may be accomplished by post processing the depth buffer after each tile is rendered.

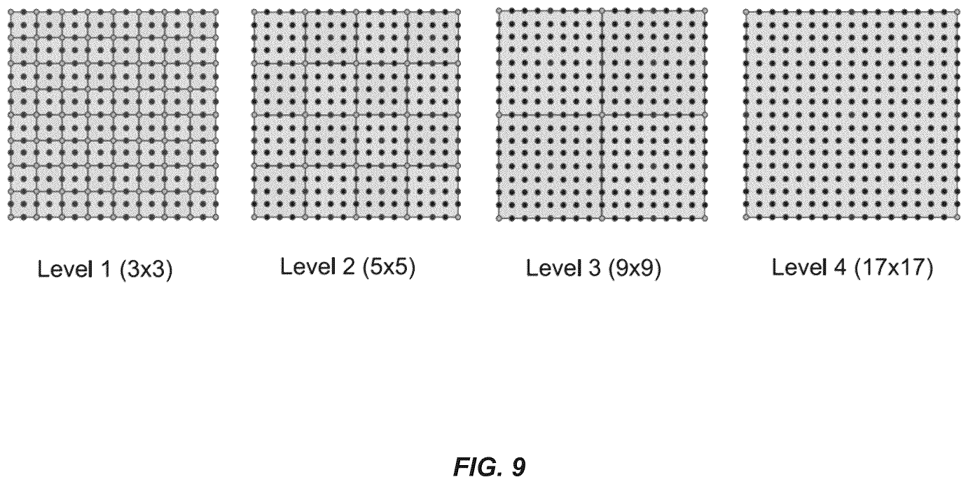

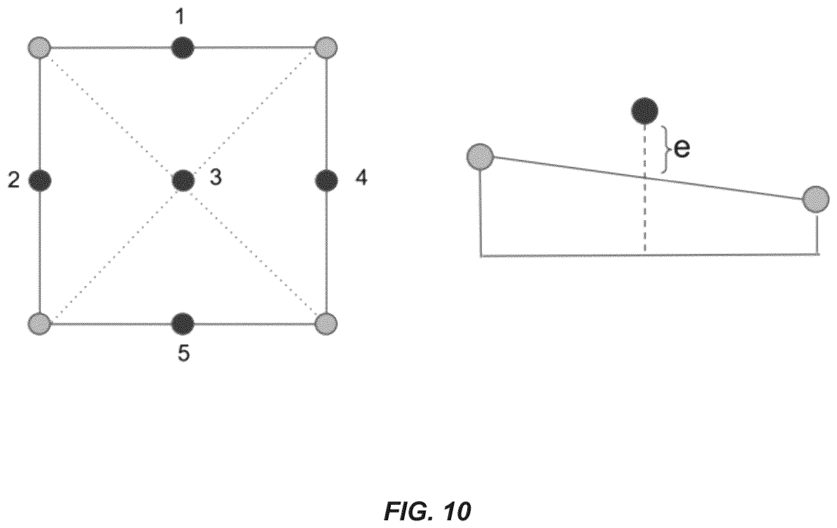

In one example, the disclosed systems and methods for improved adaptive tessellation may include reconstructing a geometry of a scene into sub-elements (e.g., triangles) using depth information stored in a depth buffer. In some embodiments, the method may include algorithmic methods to generate a triangle topology for a desired image by processing the depth buffer. The algorithmic method may adaptively tesselate a scene with triangles in spaces to keep the depth data under an inputted error rate. In other embodiments, the algorithmic method may include a hierarchal tessellation process that utilizes a set of levels (e.g., Z-buffer) where each level may be an array of quads (e.g., quads containing (2″+1)×(2″+1) points). For example, FIG. 9 shows an example array of quads, according to some embodiments of this disclosure. The quads may each share an edge with the neighboring quads in the array. In further embodiments, in each quad, a number of points are considered for tessellation (e.g., generation of triangles on each quad). In some examples, the points on each quad may be read and selectively kept and/or removed during the tessellation process on each level. For example, FIG. 10 shows example quads represented by a 5-bit value. During tessellation, a flatness test may be conducted on the points to determine whether to tessellate edges based on error considerations. The hierarchical tessellation approach may enhance efficient tessellation while maintaining visual accuracy of the desired scene. In further examples, the algorithmic method may support optimization strategies including discarding triangles if their vertices have clear values. Additionally, the algorithmic methods may support odd-sized meshes and clipped objects for compatibility with diverse rendering scenarios.

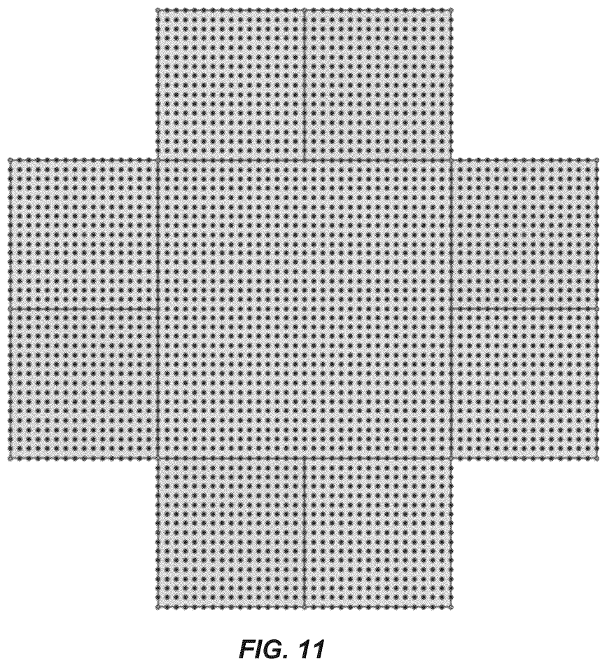

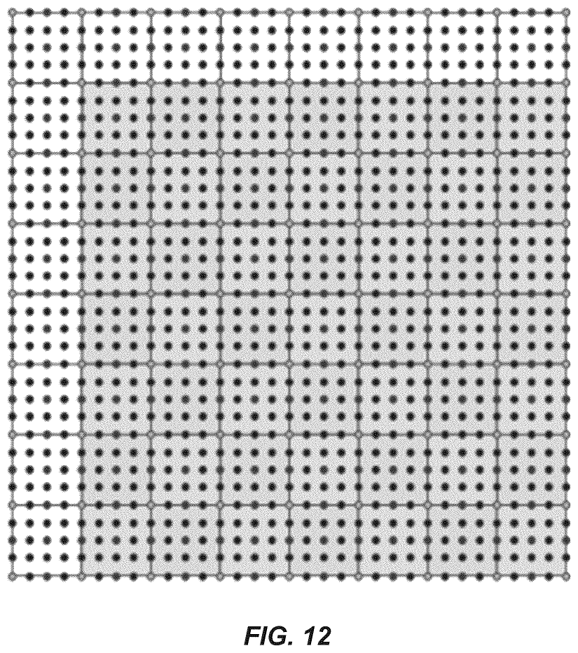

In some embodiments, the algorithmic method may include hardware implementations including tile based rendering systems. The algorithmic method may include generating a data structure for each tile that may describe the triangles representing the z-surface. In other embodiments, the algorithmic method may accelerate the generation of triangles using the tile based rendering systems. For example, FIGS. 11-12 show example adaptive tessellation quads representing a z-surface. In some examples, tiles devoid of geometry may be omitted from processing. In other examples, the tile based renderer may write quad values from one to five. In some methods, level one processing may include flatness testing and utilizing z data obtained from preceding tiles (e.g., z-data from bottom side and right side boundaries). In further methods, processing at Level two may include accessing neighboring data from Level one, typically from two adjacent sides.

### Example Embodiments

Example 4: A method including (1) reconstructing a geometry of a scene into sub-elements using depth information stored in a depth buffer; (2) specifying at least one parameter to selectively generate the sub-elements; and (3) accelerating the sub-element generation using a tile based renderer.

### Systems and Methods for Dimensional Scene Sorting

A The present disclosure is generally directed to a scene-sorting algorithm that explicitly accounts for two-dimensional (2D) content when mixed in with a three-dimensional (3D) scene. The methods and systems disclosed herein enable for users to apply labels to 2D content to group them into virtual panels. A panel may include one or more related pieces of 2D content that lie in the same 3D plane, and users may apply a label to a piece of 2D content to indicate which panel it belongs to. The methods and systems disclosed herein may also enable users to apply a relative order (e.g., Z order, rendering order, etc.) to each piece of content in the 2D panel, which may give users selective control over the order in which each piece of content on a panel will be rendered for that panel. The selective control over the rendering order may include user inputs processed in real-time, updating the rendering order dynamically.

In one example, the disclosed systems and methods for improved dimensional scene sorting may include sorting visual content (e.g., transparent and/or non-transparent elements) within a 3D scene in a rendering order (e.g., visual content including 2D and/or 3D objects). In some methods, labels may be assigned to 2D content to form virtual panels, where the panels may include related 2D elements on the same 3D plane. On each panel, a z-order for each individual piece of 2D content may be established to provide control over their rendering order. Users may adjust the z-order of the 2D elements within a panel, determining a sequence in which the elements will be rendered. In other methods, disclosed methods (e.g., scene sorting algorithm, stable sorting algorithm, etc.) may include receiving the visual content as a list of content pieces to preserve the relative order of 2D content within each virtual panel. Further, for each virtual panel, the disclosed methods may include creating a representative boundary (e.g., rectangle) and a 3D position to encapsulate a spatial extent of related 2D content. Additionally, the representative boundary may facilitate the subsequent sorting of the visual content based on depth relationships. In some examples, the disclosed methods may include preserving the render order of the visual content to accommodate the complex mixing of 2D and 3D scenes.

In other examples, the disclosed methods may include a comparison function to determine the rendering order of the visual content by identifying the elements of the visual content. In some examples, the comparison function may prioritize non-transparent (e.g., opaque) 3D content and order 3D content based on the depth of their bounding box centers. Prioritizing non-transparent 3D elements may include assigning a higher priority value to the non-transparent 3D elements among other 3D and 2D elements. In some examples, using the comparison function may include determining the rendering order of 3D content among other 3D elements based on the depth of their respective bounding box centers. In further examples, the methods described herein may calculate depth values for the boundaries of each 2D element. The depth values may be compared to establish a rendering order that aligns with the spatial hierarchy of the scene. In some embodiments, two pieces of 2D content on the same panel may be considered identical, where the order of the 2D content may be determined based on the depth of each panel boundary center. In some embodiments, two pieces of 2D content on the same panel that are not parallel (e.g., nearly parallel) may be compared by the depth of each panel boundary center. In other embodiments, two pieces of 2D content on the same panel of 2D content that are parallel may include an overlap region between the boundaries, where the depth of each boundary at the center of the overlapping region may be compared. In some instances, the boundaries void of an overlap region may be compared using the depth of each panel boundary center.

In further embodiments, ordering the 2D content may include projecting the boundary where the visual content will be rendered into a screen space. Further, the comparison function may determine an overlap region between the 2D content in the rendered image. In some embodiments, the terms “screen space” may refer to a coordinate system of a final image and/or display output of the visual content. The comparison function may transform the visual content into the screen space to determine their depths relative to the user. By transforming the visual content into screen space, the comparison function may dynamically compare each piece of 2D and 3D content based on their respective depth relationships. In some examples, comparing the visual content based on their depth relationships may include comparing the depth of the boundary around 2D elements with one or more depths of other boundaries around 3D elements. In some examples, comparing the visual content based on their depth relationships may include comparing the depth of the boundary around 3D elements with one more depths of other boundaries around 3D elements.

The disclosed scene-sorting may integrate 2D content within a 3D scene, enabling users enhanced control over the sorting and rendering of visual elements. By allowing labels and relative order assignments to 2D content, the systems disclosed herein may facilitate the creation of virtual panels that may maintain spatial relationships and rendering priorities. This approach may enable 2D and 3D content to be mixed and displayed, preserving the intended spatial hierarchy. The implementation of the methods disclosed herein may improve the accuracy and efficiency of rendering complex scenes.

Embodiments of the present disclosure may include or be implemented in conjunction with various types of Artificial-Reality (AR) systems. AR may be any superimposed functionality and/or sensory-detectable content presented by an artificial-reality system within a user's physical surroundings. In other words, AR is a form of reality that has been adjusted in some manner before presentation to a user. AR can include and/or represent virtual reality (VR), augmented reality, mixed AR (MAR), or some combination and/or variation of these types of realities. Similarly, AR environments may include VR environments (including non-immersive, semi-immersive, and fully immersive VR environments), augmented-reality environments (including marker-based augmented-reality environments, markerless augmented-reality environments, location-based augmented-reality environments, and projection-based augmented-reality environments), hybrid-reality environments, and/or any other type or form of mixed- or alternative-reality environments.

AR content may include completely computer-generated content or computer-generated content combined with captured (e.g., real-world) content. Such AR content may include video, audio, haptic feedback, or some combination thereof, any of which may be presented in a single channel or in multiple channels (such as stereo video that produces a three-dimensional (3D) effect to the viewer). Additionally, in some embodiments, AR may also be associated with applications, products, accessories, services, or some combination thereof, that are used to, for example, create content in an artificial reality and/or are otherwise used in (e.g., to perform activities in) an artificial reality.

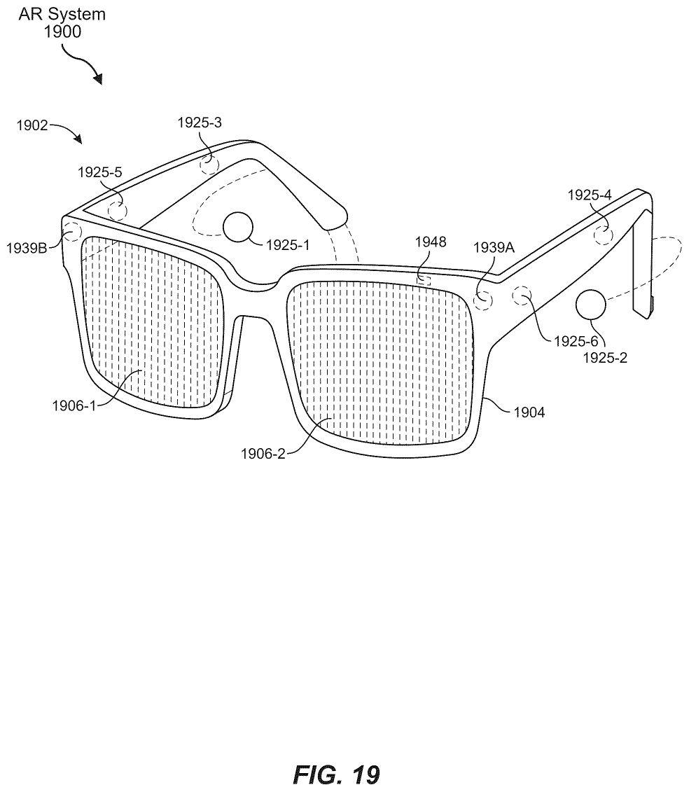

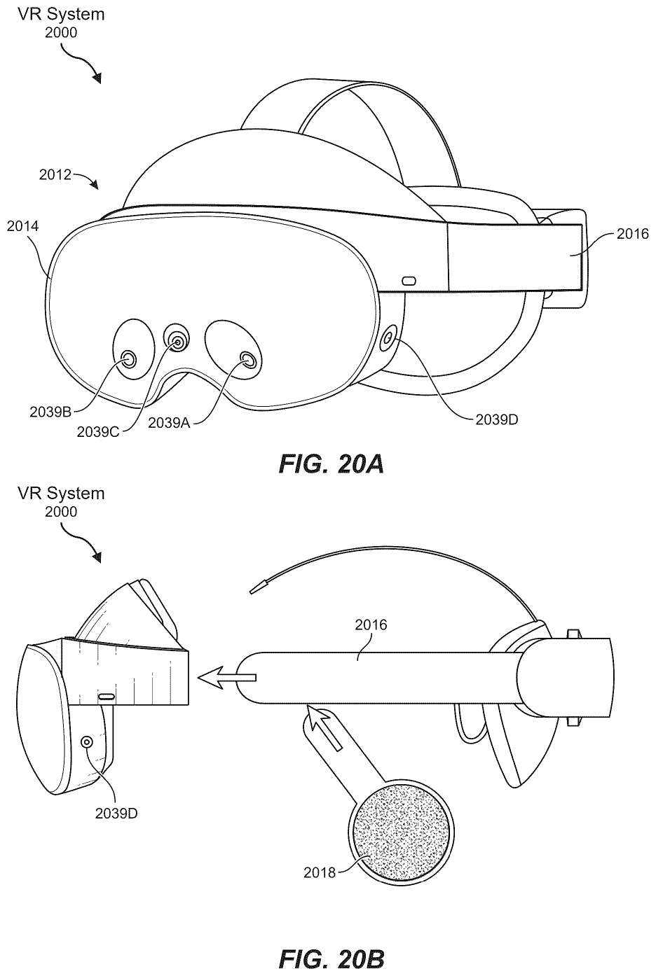

AR systems may be implemented in a variety of different form factors and configurations. Some AR systems may be designed to work without near-eye displays (NEDs). Other AR systems may include a NED that also provides visibility into the real world (such as, e.g., augmented-reality system 1900 in FIG. 19) or that visually immerses a user in an artificial reality (such as, e.g., virtual-reality system 2000 in FIGS. 20A and 20B). While some AR devices may be self-contained systems, other AR devices may communicate and/or coordinate with external devices to provide an AR experience to a user. Examples of such external devices include handheld controllers, mobile devices, desktop computers, devices worn by a user, devices worn by one or more other users, and/or any other suitable external system.

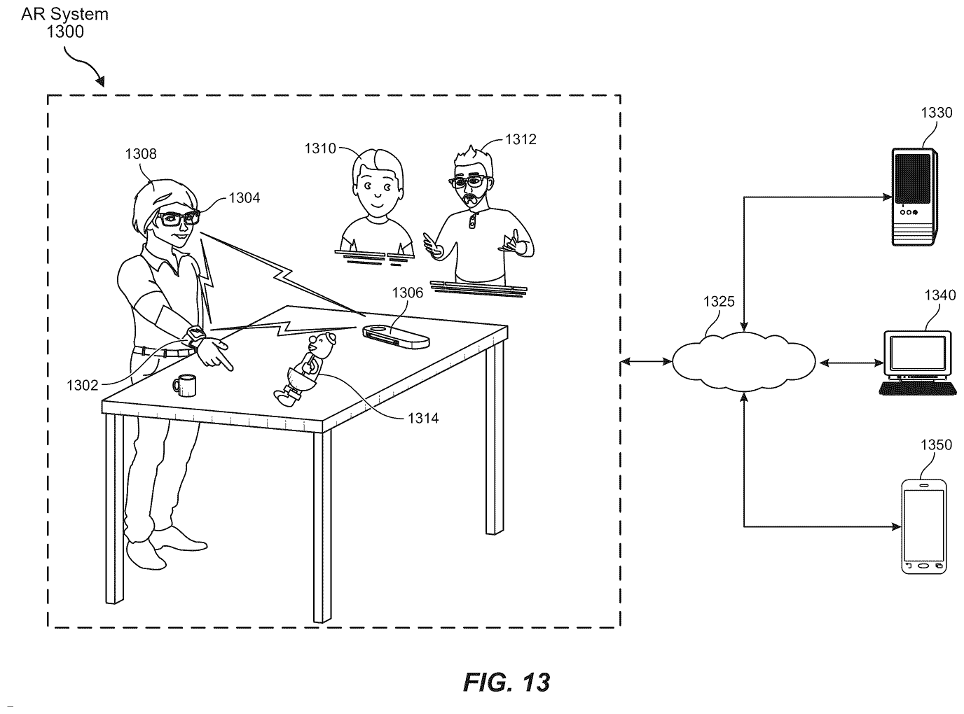

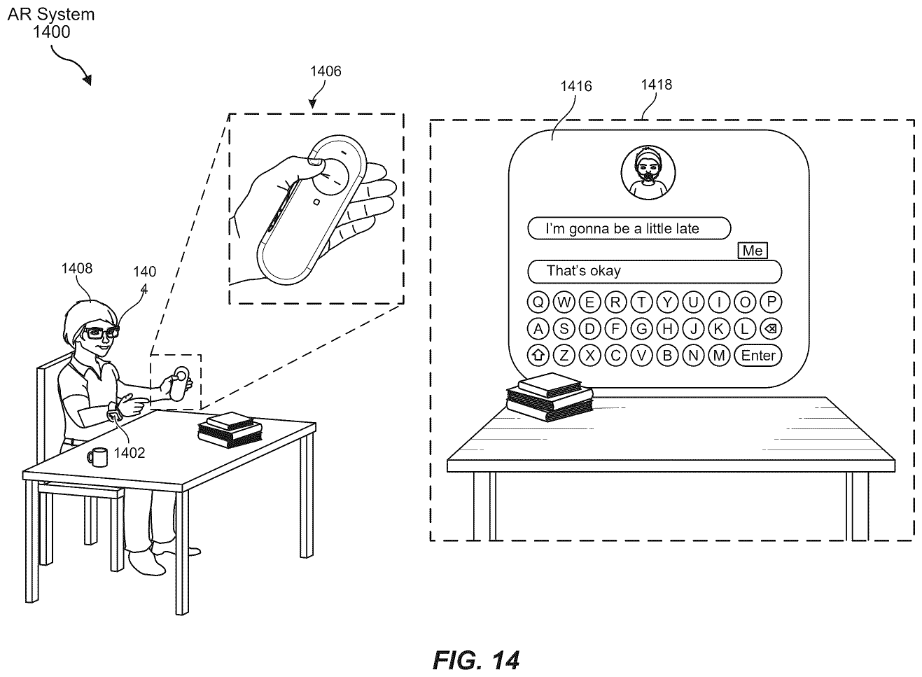

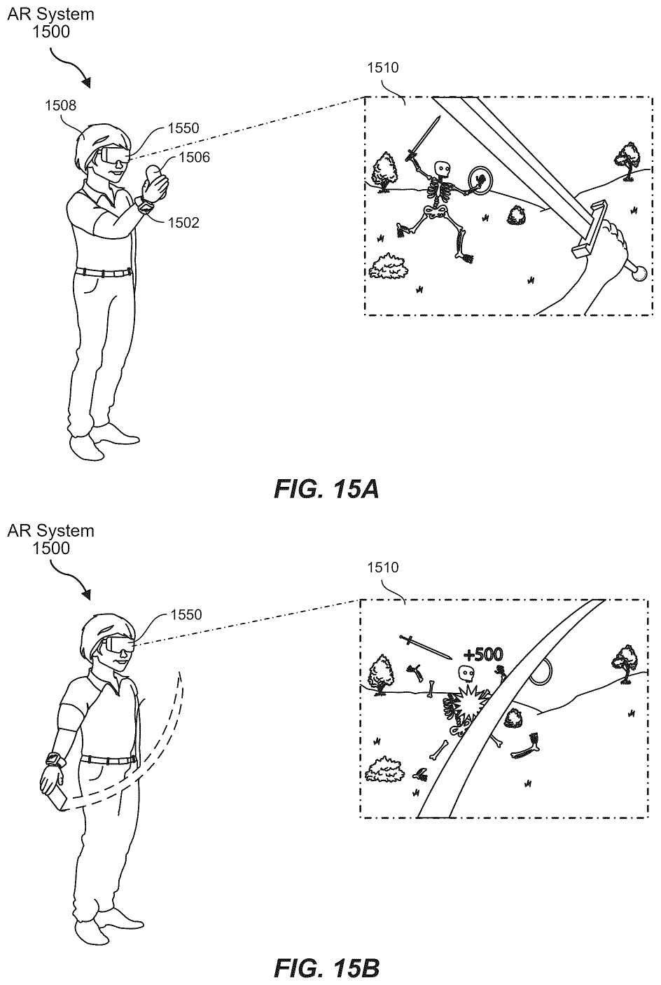

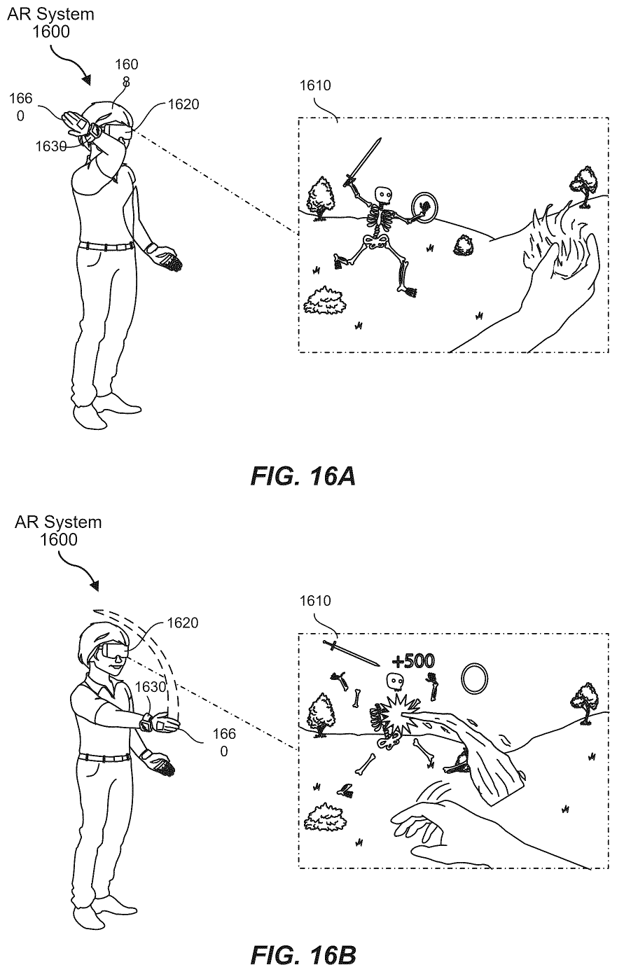

FIGS. 13-16B illustrate example artificial-reality (AR) systems in accordance with some embodiments. FIG. 13 shows a first AR system 1300 and first example user interactions using a wrist-wearable device 1302, a head-wearable device (e.g., AR glasses 1900), and/or a handheld intermediary processing device (HIPD) 1306. FIG. 14 shows a second AR system 1400 and second example user interactions using a wrist-wearable device 1402, AR glasses 1404, and/or an HIPD 1406. FIGS. 15A and 15B show a third AR system 1500 and third example user 1508 interactions using a wrist-wearable device 1502, a head-wearable device (e.g., VR headset 1550), and/or an HIPD 1506. FIGS. 16A and 16B show a fourth AR system 1600 and fourth example user 1608 interactions using a wrist-wearable device 1630, VR headset 1620, and/or a haptic device 1660 (e.g., wearable gloves).

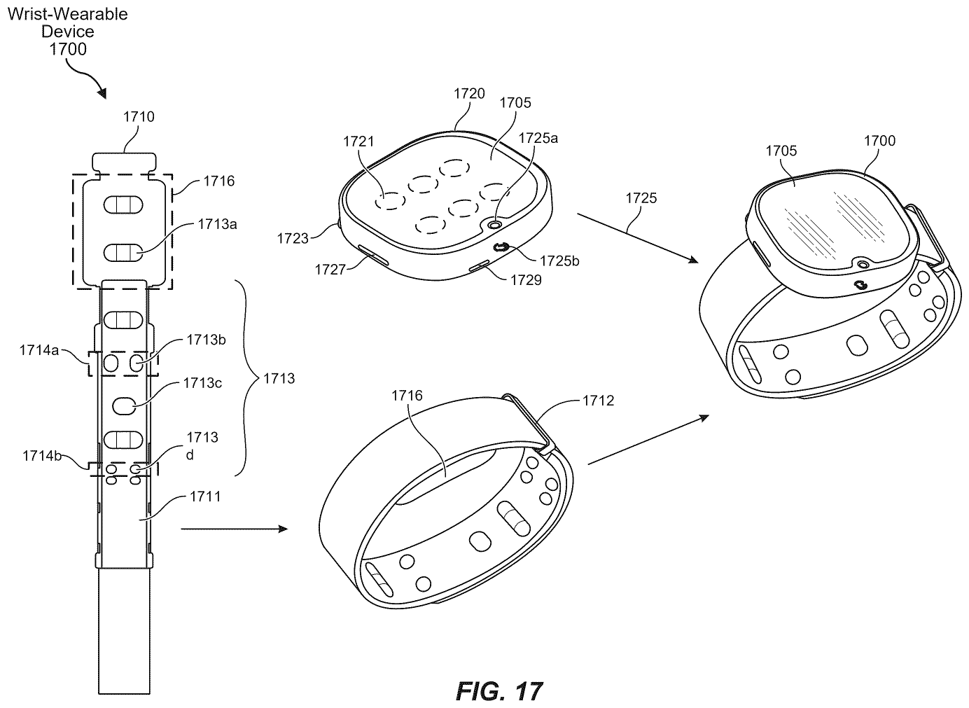

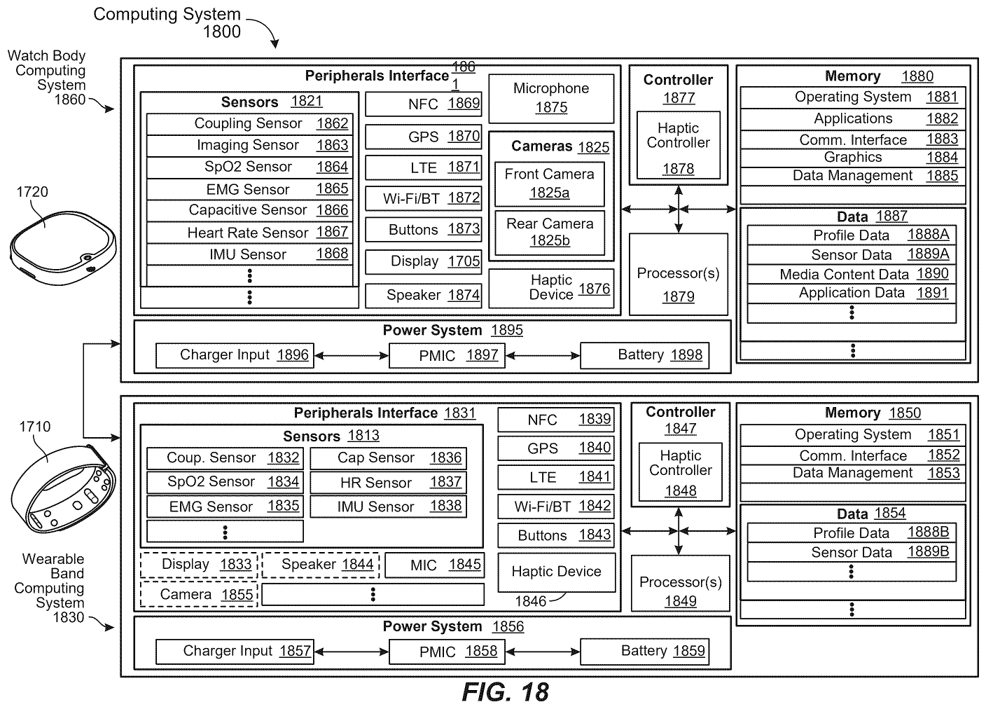

A wrist-wearable device 1700, which can be used for wrist-wearable device 1302, 1402, 1502, 1630, and one or more of its components, are described below in reference to FIGS. 17 and 18; head-wearable devices 1900 and 2000, which can respectively be used for AR glasses 1304, 1404 or VR headset 1550, 1620, and their one or more components are described below in reference to FIGS. 19-21.

Referring to FIG. 13, wrist-wearable device 1302, AR glasses 1304, and/or HIPD 1306 can communicatively couple via a network 1325 (e.g., cellular, near field, Wi-Fi, personal area network, wireless LAN, etc.). Additionally, wrist-wearable device 1302, AR glasses 1304, and/or HIPD 1306 can also communicatively couple with one or more servers 1330, computers 1340 (e.g., laptops, computers, etc.), mobile devices 1350 (e.g., smartphones, tablets, etc.), and/or other electronic devices via network 1325 (e.g., cellular, near field, Wi-Fi, personal area network, wireless LAN, etc.).

In FIG. 13, a user 1308 is shown wearing wrist-wearable device 1302 and AR glasses 1304 and having HIPD 1306 on their desk. The wrist-wearable device 1302, AR glasses 1304, and HIPD 1306 facilitate user interaction with an AR environment. In particular, as shown by first AR system 1300, wrist-wearable device 1302, AR glasses 1304, and/or HIPD 1306 cause presentation of one or more avatars 1310, digital representations of contacts 1312, and virtual objects 1314. As discussed below, user 1308 can interact with one or more avatars 1310, digital representations of contacts 1312, and virtual objects 1314 via wrist-wearable device 1302, AR glasses 1304, and/or HIPD 1306.

User 1308 can use any of wrist-wearable device 1302, AR glasses 1304, and/or HIPD 1306 to provide user inputs. For example, user 1308 can perform one or more hand gestures that are detected by wrist-wearable device 1302 (e.g., using one or more EMG sensors and/or IMUs, described below in reference to FIGS. 17 and 18) and/or AR glasses 1304 (e.g., using one or more image sensor or camera, described below in reference to FIGS. 19-10) to provide a user input. Alternatively, or additionally, user 1308 can provide a user input via one or more touch surfaces of wrist-wearable device 1302, AR glasses 1304, HIPD 1306, and/or voice commands captured by a microphone of wrist-wearable device 1302, AR glasses 1304, and/or HIPD 1306. In some embodiments, wrist-wearable device 1302, AR glasses 1304, and/or HIPD 1306 include a digital assistant to help user 1308 in providing a user input (e.g., completing a sequence of operations, suggesting different operations or commands, providing reminders, confirming a command, etc.). In some embodiments, user 1308 can provide a user input via one or more facial gestures and/or facial expressions. For example, cameras of wrist-wearable device 1302, AR glasses 1304, and/or HIPD 1306 can track eyes of user 1308 for navigating a user interface.

Wrist-wearable device 1302, AR glasses 1304, and/or HIPD 1306 can operate alone or in conjunction to allow user 1308 to interact with the AR environment. In some embodiments, HIPD 1306 is configured to operate as a central hub or control center for the wrist-wearable device 1302, AR glasses 1304, and/or another communicatively coupled device. For example, user 1308 can provide an input to interact with the AR environment at any of wrist-wearable device 1302, AR glasses 1304, and/or HIPD 1306, and HIPD 1306 can identify one or more back-end and front-end tasks to cause the performance of the requested interaction and distribute instructions to cause the performance of the one or more back-end and front-end tasks at wrist-wearable device 1302, AR glasses 1304, and/or HIPD 1306. In some embodiments, a back-end task is a background processing task that is not perceptible by the user (e.g., rendering content, decompression, compression, etc.), and a front-end task is a user-facing task that is perceptible to the user (e.g., presenting information to the user, providing feedback to the user, etc.). As described below, HIPD 1306 can perform the back-end tasks and provide wrist-wearable device 1302 and/or AR glasses 1304 operational data corresponding to the performed back-end tasks such that wrist-wearable device 1302 and/or AR glasses 1304 can perform the front-end tasks. In this way, HIPD 1306, which has more computational resources and greater thermal headroom than wrist-wearable device 1302 and/or AR glasses 1304, performs computationally intensive tasks and reduces the computer resource utilization and/or power usage of wrist-wearable device 1302 and/or AR glasses 1304.

In the example shown by first AR system 1300, HIPD 1306 identifies one or more back-end tasks and front-end tasks associated with a user request to initiate an AR video call with one or more other users (represented by avatar 1310 and the digital representation of contact 1312) and distributes instructions to cause the performance of the one or more back-end tasks and front-end tasks. In particular, HIPD 1306 performs back-end tasks for processing and/or rendering image data (and other data) associated with the AR video call and provides operational data associated with the performed back-end tasks to AR glasses 1304 such that the AR glasses 1304 perform front-end tasks for presenting the AR video call (e.g., presenting avatar 1310 and digital representation of contact 1312).

In some embodiments, HIPD 1306 can operate as a focal or anchor point for causing the presentation of information. This allows user 1308 to be generally aware of where information is presented. For example, as shown in first AR system 1300, avatar 1310 and the digital representation of contact 1312 are presented above HIPD 1306. In particular, HIPD 1306 and AR glasses 1304 operate in conjunction to determine a location for presenting avatar 1310 and the digital representation of contact 1312. In some embodiments, information can be presented a predetermined distance from HIPD 1306 (e.g., within 5 meters). For example, as shown in first AR system 1300, virtual object 1314 is presented on the desk some distance from HIPD 1306. Similar to the above example, HIPD 1306 and AR glasses 1304 can operate in conjunction to determine a location for presenting virtual object 1314. Alternatively, in some embodiments, presentation of information is not bound by HIPD 1306. More specifically, avatar 1310, digital representation of contact 1312, and virtual object 1314 do not have to be presented within a predetermined distance of HIPD 1306.

User inputs provided at wrist-wearable device 1302, AR glasses 1304, and/or HIPD 1306 are coordinated such that the user can use any device to initiate, continue, and/or complete an operation. For example, user 1308 can provide a user input to AR glasses 1304 to cause AR glasses 1304 to present virtual object 1314 and, while virtual object 1314 is presented by AR glasses 1304, user 1308 can provide one or more hand gestures via wrist-wearable device 1302 to interact and/or manipulate virtual object 1314.

FIG. 14 shows a user 1408 wearing a wrist-wearable device 1402 and AR glasses 1404, and holding an HIPD 1406. In second AR system 1400, the wrist-wearable device 1402, AR glasses 1404, and/or HIPD 1406 are used to receive and/or provide one or more messages to a contact of user 1408. In particular, wrist-wearable device 1402, AR glasses 1404, and/or HIPD 1406 detect and coordinate one or more user inputs to initiate a messaging application and prepare a response to a received message via the messaging application.

In some embodiments, user 1408 initiates, via a user input, an application on wrist-wearable device 1402, AR glasses 1404, and/or HIPD 1406 that causes the application to initiate on at least one device. For example, in second AR system 1400, user 1408 performs a hand gesture associated with a command for initiating a messaging application (represented by messaging user interface 1416), wrist-wearable device 1402 detects the hand gesture and, based on a determination that user 1408 is wearing AR glasses 1404, causes AR glasses 1404 to present a messaging user interface 1416 of the messaging application. AR glasses 1404 can present messaging user interface 1416 to user 1408 via its display (e.g., as shown by a field of view 1418 of user 1408). In some embodiments, the application is initiated and executed on the device (e.g., wrist-wearable device 1402, AR glasses 1404, and/or HIPD 1406) that detects the user input to initiate the application, and the device provides another device operational data to cause the presentation of the messaging application. For example, wrist-wearable device 1402 can detect the user input to initiate a messaging application, initiate and run the messaging application, and provide operational data to AR glasses 1404 and/or HIPD 1406 to cause presentation of the messaging application. Alternatively, the application can be initiated and executed at a device other than the device that detected the user input. For example, wrist-wearable device 1402 can detect the hand gesture associated with initiating the messaging application and cause HIPD 1406 to run the messaging application and coordinate the presentation of the messaging application.

Further, user 1408 can provide a user input provided at wrist-wearable device 1402, AR glasses 1404, and/or HIPD 1406 to continue and/or complete an operation initiated at another device. For example, after initiating the messaging application via wrist-wearable device 1402 and while AR glasses 1404 present messaging user interface 1416, user 1408 can provide an input at HIPD 1406 to prepare a response (e.g., shown by the swipe gesture performed on HIPD 1406). Gestures performed by user 1408 on HIPD 1406 can be provided and/or displayed on another device. For example, a swipe gestured performed on HIPD 1406 is displayed on a virtual keyboard of messaging user interface 1416 displayed by AR glasses 1404.

In some embodiments, wrist-wearable device 1402, AR glasses 1404, HIPD 1406, and/or any other communicatively coupled device can present one or more notifications to user 1408. The notification can be an indication of a new message, an incoming call, an application update, a status update, etc. User 1408 can select the notification via wrist-wearable device 1402, AR glasses 1404, and/or HIPD 1406 and can cause presentation of an application or operation associated with the notification on at least one device. For example, user 1408 can receive a notification that a message was received at wrist-wearable device 1402, AR glasses 1404, HIPD 1406, and/or any other communicatively coupled device and can then provide a user input at wrist-wearable device 1402, AR glasses 1404, and/or HIPD 1406 to review the notification, and the device detecting the user input can cause an application associated with the notification to be initiated and/or presented at wrist-wearable device 1402, AR glasses 1404, and/or HIPD 1406.

While the above example describes coordinated inputs used to interact with a messaging application, user inputs can be coordinated to interact with any number of applications including, but not limited to, gaming applications, social media applications, camera applications, web-based applications, financial applications, etc. For example, AR glasses 1404 can present to user 1408 game application data, and HIPD 1406 can be used as a controller to provide inputs to the game. Similarly, user 1408 can use wrist-wearable device 1402 to initiate a camera of AR glasses 1404, and user 308 can use wrist-wearable device 1402, AR glasses 1404, and/or HIPD 1406 to manipulate the image capture (e.g., zoom in or out, apply filters, etc.) and capture image data.

Users may interact with the devices disclosed herein in a variety of ways. For example, as shown in FIGS. 15A and 15B, a user 1508 may interact with an AR system 1500 by donning a VR headset 1550 while holding HIPD 1506 and wearing wrist-wearable device 1502. In this example, AR system 1500 may enable a user to interact with a game 1510 by swiping their arm. One or more of VR headset 1550, HIPD 1506, and wrist-wearable device 1502 may detect this gesture and, in response, may display a sword strike in game 1510. Similarly, in FIGS. 16A and 16B, a user 1608 may interact with an AR system 1600 by donning a VR headset 1620 while wearing haptic device 1660 and wrist-wearable device 1630. In this example, AR system 1600 may enable a user to interact with a game 1610 by swiping their arm. One or more of VR headset 1620, haptic device 1660, and wrist-wearable device 1630 may detect this gesture and, in response, may display a spell being cast in game 1510.

Having discussed example AR systems, devices for interacting with such AR systems and other computing systems more generally will now be discussed in greater detail. Some explanations of devices and components that can be included in some or all of the example devices discussed below are explained herein for ease of reference. Certain types of the components described below may be more suitable for a particular set of devices, and less suitable for a different set of devices. But subsequent reference to the components explained here should be considered to be encompassed by the descriptions provided.

In some embodiments discussed below, example devices and systems, including electronic devices and systems, will be addressed. Such example devices and systems are not intended to be limiting, and one of skill in the art will understand that alternative devices and systems to the example devices and systems described herein may be used to perform the operations and construct the systems and devices that are described herein.

An electronic device may be a device that uses electrical energy to perform a specific function. An electronic device can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device may be a device that sits between two other electronic devices and/or a subset of components of one or more electronic devices and facilitates communication, data processing, and/or data transfer between the respective electronic devices and/or electronic components.

An integrated circuit may be an electronic device made up of multiple interconnected electronic components such as transistors, resistors, and capacitors. These components may be etched onto a small piece of semiconductor material, such as silicon. Integrated circuits may include analog integrated circuits, digital integrated circuits, mixed signal integrated circuits, and/or any other suitable type or form of integrated circuit. Examples of integrated circuits include application-specific integrated circuits (ASICs), processing units, central processing units (CPUs), co-processors, and accelerators.

Analog integrated circuits, such as sensors, power management circuits, and operational amplifiers, may process continuous signals and perform analog functions such as amplification, active filtering, demodulation, and mixing. Examples of analog integrated circuits include linear integrated circuits and radio frequency circuits.

Digital integrated circuits, which may be referred to as logic integrated circuits, may include microprocessors, microcontrollers, memory chips, interfaces, power management circuits, programmable devices, and/or any other suitable type or form of integrated circuit. In some embodiments, examples of integrated circuits include central processing units (CPUs),

Processing units, such as CPUs, may be electronic components that are responsible for executing instructions and controlling the operation of an electronic device (e.g., a computer). There are various types of processors that may be used interchangeably, or may be specifically required, by embodiments described herein. For example, a processor may be: (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) an accelerator, such as a graphics processing unit (GPU), designed to accelerate the creation and rendering of images, videos, and animations (e.g., virtual-reality animations, such as three-dimensional modeling); (iv) a field-programmable gate array (FPGA) that can be programmed and reconfigured after manufacturing and/or can be customized to perform specific tasks, such as signal processing, cryptography, and machine learning; and/or (v) a digital signal processor (DSP) designed to perform mathematical operations on signals such as audio, video, and radio waves. One or more processors of one or more electronic devices may be used in various embodiments described herein.

Memory generally refers to electronic components in a computer or electronic device that store data and instructions for the processor to access and manipulate. Examples of memory can include: (i) random access memory (RAM) configured to store data and instructions temporarily; (ii) read-only memory (ROM) configured to store data and instructions permanently (e.g., one or more portions of system firmware, and/or boot loaders) and/or semi-permanently; (iii) flash memory, which can be configured to store data in electronic devices (e.g., USB drives, memory cards, and/or solid-state drives (SSDs)); and/or (iv) cache memory configured to temporarily store frequently accessed data and instructions. Memory, as described herein, can store structured data (e.g., SQL databases, MongoDB databases, GraphQL data, JSON data, etc.). Other examples of data stored in memory can include (i) profile data, including user account data, user settings, and/or other user data stored by the user, (ii) sensor data detected and/or otherwise obtained by one or more sensors, (iii) media content data including stored image data, audio data, documents, and the like, (iv) application data, which can include data collected and/or otherwise obtained and stored during use of an application, and/or any other types of data described herein.

Controllers may be electronic components that manage and coordinate the operation of other components within an electronic device (e.g., controlling inputs, processing data, and/or generating outputs). Examples of controllers can include: (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs.

A power system of an electronic device may be configured to convert incoming electrical power into a form that can be used to operate the device. A power system can include various components, such as (i) a power source, which can be an alternating current (AC) adapter or a direct current (DC) adapter power supply, (ii) a charger input, which can be configured to use a wired and/or wireless connection (which may be part of a peripheral interface, such as a USB, micro-USB interface, near-field magnetic coupling, magnetic inductive and magnetic resonance charging, and/or radio frequency (RF) charging), (iii) a power-management integrated circuit, configured to distribute power to various components of the device and to ensure that the device operates within safe limits (e.g., regulating voltage, controlling current flow, and/or managing heat dissipation), and/or (iv) a battery configured to store power to provide usable power to components of one or more electronic devices.

Peripheral interfaces may be electronic components (e.g., of electronic devices) that allow electronic devices to communicate with other devices or peripherals and can provide the ability to input and output data and signals. Examples of peripheral interfaces can include (i) universal serial bus (USB) and/or micro-USB interfaces configured for connecting devices to an electronic device, (ii) Bluetooth interfaces configured to allow devices to communicate with each other, including Bluetooth low energy (BLE), (iii) near field communication (NFC) interfaces configured to be short-range wireless interfaces for operations such as access control, (iv) POGO pins, which may be small, spring-loaded pins configured to provide a charging interface, (v) wireless charging interfaces, (vi) GPS interfaces, (vii) Wi-Fi interfaces for providing a connection between a device and a wireless network, and/or (viii) sensor interfaces.

Sensors may be electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device), (ii) biopotential-signal sensors, (iii) inertial measurement units (e.g., IMUs) for detecting, for example, angular rate, force, magnetic field, and/or changes in acceleration, (iv) heart rate sensors for measuring a user's heart rate, (v) SpO2 sensors for measuring blood oxygen saturation and/or other biometric data of a user, (vi) capacitive sensors for detecting changes in potential at a portion of a user's body (e.g., a sensor-skin interface), and/or (vii) light sensors (e.g., time-of-flight sensors, infrared light sensors, visible light sensors, etc.).

Biopotential-signal-sensing components may be devices used to measure electrical activity within the body (e.g., biopotential-signal sensors). Some types of biopotential-signal sensors include (i) electroencephalography (EEG) sensors configured to measure electrical activity in the brain to diagnose neurological disorders, (ii) electrocardiogram EKG) sensors configured to measure electrical activity of the heart to diagnose heart problems, (iii) electromyography (EMG) sensors configured to measure the electrical activity of muscles and to diagnose neuromuscular disorders, and (iv) electrooculography (EOG) sensors configure to measure the electrical activity of eye muscles to detect eye movement and diagnose eye disorders.

An application stored in memory of an electronic device (e.g., software) may include instructions stored in the memory. Examples of such applications include (i) games, (ii) word processors, (iii) messaging applications, (iv) media-streaming applications, (v) financial applications, (vi) calendars. (vii) clocks, and (viii) communication interface modules for enabling wired and/or wireless connections between different respective electronic devices (e.g., IEEE 1902.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocols).

A communication interface may be a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, Bluetooth). In some embodiments, a communication interface can refer to a software layer that enables different software programs to communicate with each other (e.g., application programming interfaces (APIs), protocols like HTTP and TCP/IP, etc.).

A graphics module may be a component or software module that is designed to handle graphical operations and/or processes and can include a hardware module and/or a software module.

Non-transitory computer-readable storage media may be physical devices or storage media that can be used to store electronic data in a non-transitory form (e.g., such that the data is stored permanently until it is intentionally deleted or modified).

FIGS. 17 and 18 illustrate an example wrist-wearable device 1700 and an example computer system 1800, in accordance with some embodiments. Wrist-wearable device 1700 is an instance of wearable device 1302 described in FIG. 13 herein, such that the wearable device 1302 should be understood to have the features of the wrist-wearable device 1700 and vice versa. FIG. 18 illustrates components of the wrist-wearable device 1700, which can be used individually or in combination, including combinations that include other electronic devices and/or electronic components.

FIG. 17 shows a wearable band 1710 and a watch body 1720 (or capsule) being coupled, as discussed below, to form wrist-wearable device 1700. Wrist-wearable device 1700 can perform various functions and/or operations associated with navigating through user interfaces and selectively opening applications as well as the functions and/or operations described above with reference to FIGS. 13-16B.

As will be described in more detail below, operations executed by wrist-wearable device 1700 can include (i) presenting content to a user (e.g., displaying visual content via a display 1705), (ii) detecting (e.g., sensing) user input (e.g., sensing a touch on peripheral button 1723 and/or at a touch screen of the display 1705, a hand gesture detected by sensors (e.g., biopotential sensors)), (iii) sensing biometric data (e.g., neuromuscular signals, heart rate, temperature, sleep, etc.) via one or more sensors 1713, messaging (e.g., text, speech, video, etc.); image capture via one or more imaging devices or cameras 1725, wireless communications (e.g., cellular, near field, Wi-Fi, personal area network, etc.), location determination, financial transactions, providing haptic feedback, providing alarms, providing notifications, providing biometric authentication, providing health monitoring, providing sleep monitoring, etc.

The above-example functions can be executed independently in watch body 1720, independently in wearable band 1710, and/or via an electronic communication between watch body 1720 and wearable band 1710. In some embodiments, functions can be executed on wrist-wearable device 1700 while an AR environment is being presented (e.g., via one of AR systems 1300 to 1600). The wearable devices described herein can also be used with other types of AR environments.

Wearable band 1710 can be configured to be worn by a user such that an inner surface of a wearable structure 1711 of wearable band 1710 is in contact with the user's skin. In this example, when worn by a user, sensors 1713 may contact the user's skin. In some examples, one or more of sensors 1713 can sense biometric data such as a user's heart rate, a saturated oxygen level, temperature, sweat level, neuromuscular signals, or a combination thereof. One or more of sensors 1713 can also sense data about a user's environment including a user's motion, altitude, location, orientation, gait, acceleration, position, or a combination thereof. In some embodiment, one or more of sensors 1713 can be configured to track a position and/or motion of wearable band 1710. One or more of sensors 1713 can include any of the sensors defined above and/or discussed below with respect to FIG. 17.

One or more of sensors 1713 can be distributed on an inside and/or an outside surface of wearable band 1710. In some embodiments, one or more of sensors 1713 are uniformly spaced along wearable band 1710. Alternatively, in some embodiments, one or more of sensors 1713 are positioned at distinct points along wearable band 1710. As shown in FIG. 17, one or more of sensors 1713 can be the same or distinct. For example, in some embodiments, one or more of sensors 1713 can be shaped as a pill (e.g., sensor 1713a), an oval, a circle a square, an oblong (e.g., sensor 1713c) and/or any other shape that maintains contact with the user's skin (e.g., such that neuromuscular signal and/or other biometric data can be accurately measured at the user's skin). In some embodiments, one or more sensors of 1713 are aligned to form pairs of sensors (e.g., for sensing neuromuscular signals based on differential sensing within each respective sensor). For example, sensor 1713b may be aligned with an adjacent sensor to form sensor pair 1714a and sensor 1713d may be aligned with an adjacent sensor to form sensor pair 1714b. In some embodiments, wearable band 1710 does not have a sensor pair. Alternatively, in some embodiments, wearable band 1710 has a predetermined number of sensor pairs (one pair of sensors, three pairs of sensors, four pairs of sensors, six pairs of sensors, sixteen pairs of sensors, etc.).

Wearable band 1710 can include any suitable number of sensors 1713. In some embodiments, the number and arrangement of sensors 1713 depends on the particular application for which wearable band 1710 is used. For instance, wearable band 1710 can be configured as an armband, wristband, or chest-band that include a plurality of sensors 1713 with different number of sensors 1713, a variety of types of individual sensors with the plurality of sensors 1713, and different arrangements for each use case, such as medical use cases as compared to gaming or general day-to-day use cases.

In accordance with some embodiments, wearable band 1710 further includes an electrical ground electrode and a shielding electrode. The electrical ground and shielding electrodes, like the sensors 1713, can be distributed on the inside surface of the wearable band 1710 such that they contact a portion of the user's skin. For example, the electrical ground and shielding electrodes can be at an inside surface of a coupling mechanism 1716 or an inside surface of a wearable structure 1711. The electrical ground and shielding electrodes can be formed and/or use the same components as sensors 1713. In some embodiments, wearable band 1710 includes more than one electrical ground electrode and more than one shielding electrode.

Sensors 1713 can be formed as part of wearable structure 1711 of wearable band 1710. In some embodiments, sensors 1713 are flush or substantially flush with wearable structure 1711 such that they do not extend beyond the surface of wearable structure 1711. While flush with wearable structure 1711, sensors 1713 are still configured to contact the user's skin (e.g., via a skin-contacting surface). Alternatively, in some embodiments, sensors 1713 extend beyond wearable structure 1711 a predetermined distance (e.g., 0.1-2 mm) to make contact and depress into the user's skin. In some embodiment, sensors 1713 are coupled to an actuator (not shown) configured to adjust an extension height (e.g., a distance from the surface of wearable structure 1711) of sensors 1713 such that sensors 1713 make contact and depress into the user's skin. In some embodiments, the actuators adjust the extension height between 0.01 mm-1.2 mm. This may allow a the user to customize the positioning of sensors 1713 to improve the overall comfort of the wearable band 1710 when worn while still allowing sensors 1713 to contact the user's skin. In some embodiments, sensors 1713 are indistinguishable from wearable structure 1711 when worn by the user.

Wearable structure 1711 can be formed of an elastic material, elastomers, etc., configured to be stretched and fitted to be worn by the user. In some embodiments, wearable structure 1711 is a textile or woven fabric. As described above, sensors 1713 can be formed as part of a wearable structure 1711. For example, sensors 1713 can be molded into the wearable structure 1711, be integrated into a woven fabric (e.g., sensors 1713 can be sewn into the fabric and mimic the pliability of fabric and can and/or be constructed from a series woven strands of fabric).

Wearable structure 1711 can include flexible electronic connectors that interconnect sensors 1713, the electronic circuitry, and/or other electronic components (described below in reference to FIG. 18) that are enclosed in wearable band 1710. In some embodiments, the flexible electronic connectors are configured to interconnect sensors 1713, the electronic circuitry, and/or other electronic components of wearable band 1710 with respective sensors and/or other electronic components of another electronic device (e.g., watch body 1720). The flexible electronic connectors are configured to move with wearable structure 1711 such that the user adjustment to wearable structure 1711 (e.g., resizing, pulling, folding, etc.) does not stress or strain the electrical coupling of components of wearable band 1710.

As described above, wearable band 1710 is configured to be worn by a user. In particular, wearable band 1710 can be shaped or otherwise manipulated to be worn by a user. For example, wearable band 1710 can be shaped to have a substantially circular shape such that it can be configured to be worn on the user's lower arm or wrist. Alternatively, wearable band 1710 can be shaped to be worn on another body part of the user, such as the user's upper arm (e.g., around a bicep), forearm, chest, legs, etc. Wearable band 1710 can include a retaining mechanism 1712 (e.g., a buckle, a hook and loop fastener, etc.) for securing wearable band 1710 to the user's wrist or other body part. While wearable band 1710 is worn by the user, sensors 1713 sense data (referred to as sensor data) from the user's skin. In some examples, sensors 1713 of wearable band 1710 obtain (e.g., sense and record) neuromuscular signals.

The sensed data (e.g., sensed neuromuscular signals) can be used to detect and/or determine the user's intention to perform certain motor actions. In some examples, sensors 1713 may sense and record neuromuscular signals from the user as the user performs muscular activations (e.g., movements, gestures, etc.). The detected and/or determined motor actions (e.g., phalange (or digit) movements, wrist movements, hand movements, and/or other muscle intentions) can be used to determine control commands or control information (instructions to perform certain commands after the data is sensed) for causing a computing device to perform one or more input commands. For example, the sensed neuromuscular signals can be used to control certain user interfaces displayed on display 1705 of wrist-wearable device 1700 and/or can be transmitted to a device responsible for rendering an artificial-reality environment (e.g., a head-mounted display) to perform an action in an associated artificial-reality environment, such as to control the motion of a virtual device displayed to the user. The muscular activations performed by the user can include static gestures, such as placing the user's hand palm down on a table, dynamic gestures, such as grasping a physical or virtual object, and covert gestures that are imperceptible to another person, such as slightly tensing a joint by co-contracting opposing muscles or using sub-muscular activations. The muscular activations performed by the user can include symbolic gestures (e.g., gestures mapped to other gestures, interactions, or commands, for example, based on a gesture vocabulary that specifies the mapping of gestures to commands).

The sensor data sensed by sensors 1713 can be used to provide a user with an enhanced interaction with a physical object (e.g., devices communicatively coupled with wearable band 1710) and/or a virtual object in an artificial-reality application generated by an artificial-reality system (e.g., user interface objects presented on the display 1705, or another computing device (e.g., a smartphone)).

In some embodiments, wearable band 1710 includes one or more haptic devices 1846 (e.g., a vibratory haptic actuator) that are configured to provide haptic feedback (e.g., a cutaneous and/or kinesthetic sensation, etc.) to the user's skin. Sensors 1713 and/or haptic devices 1846 (shown in FIG. 18) can be configured to operate in conjunction with multiple applications including, without limitation, health monitoring, social media, games, and artificial reality (e.g., the applications associated with artificial reality).

Wearable band 1710 can also include coupling mechanism 1716 for detachably coupling a capsule (e.g., a computing unit) or watch body 1720 (via a coupling surface of the watch body 1720) to wearable band 1710. For example, a cradle or a shape of coupling mechanism 1716 can correspond to shape of watch body 1720 of wrist-wearable device 1700. In particular, coupling mechanism 1716 can be configured to receive a coupling surface proximate to the bottom side of watch body 1720 (e.g., a side opposite to a front side of watch body 1720 where display 1705 is located), such that a user can push watch body 1720 downward into coupling mechanism 1716 to attach watch body 1720 to coupling mechanism 1716. In some embodiments, coupling mechanism 1716 can be configured to receive a top side of the watch body 1720 (e.g., a side proximate to the front side of watch body 1720 where display 1705 is located) that is pushed upward into the cradle, as opposed to being pushed downward into coupling mechanism 1716. In some embodiments, coupling mechanism 1716 is an integrated component of wearable band 1710 such that wearable band 1710 and coupling mechanism 1716 are a single unitary structure. In some embodiments, coupling mechanism 1716 is a type of frame or shell that allows watch body 1720 coupling surface to be retained within or on wearable band 1710 coupling mechanism 1716 (e.g., a cradle, a tracker band, a support base, a clasp, etc.).

Coupling mechanism 1716 can allow for watch body 1720 to be detachably coupled to the wearable band 1710 through a friction fit, magnetic coupling, a rotation-based connector, a shear-pin coupler, a retention spring, one or more magnets, a clip, a pin shaft, a hook and loop fastener, or a combination thereof. A user can perform any type of motion to couple the watch body 1720 to wearable band 1710 and to decouple the watch body 1720 from the wearable band 1710. For example, a user can twist, slide, turn, push, pull, or rotate watch body 1720 relative to wearable band 1710, or a combination thereof, to attach watch body 1720 to wearable band 1710 and to detach watch body 1720 from wearable band 1710. Alternatively, as discussed below, in some embodiments, the watch body 1720 can be decoupled from the wearable band 1710 by actuation of a release mechanism 1729.

Wearable band 1710 can be coupled with watch body 1720 to increase the functionality of wearable band 1710 (e.g., converting wearable band 1710 into wrist-wearable device 1700, adding an additional computing unit and/or battery to increase computational resources and/or a battery life of wearable band 1710, adding additional sensors to improve sensed data, etc.). As described above, wearable band 1710 and coupling mechanism 1716 are configured to operate independently (e.g., execute functions independently) from watch body 1720. For example, coupling mechanism 1716 can include one or more sensors 1713 that contact a user's skin when wearable band 1710 is worn by the user, with or without watch body 1720 and can provide sensor data for determining control commands.

A user can detach watch body 1720 from wearable band 1710 to reduce the encumbrance of wrist-wearable device 1700 to the user. For embodiments in which watch body 1720 is removable, watch body 1720 can be referred to as a removable structure, such that in these embodiments wrist-wearable device 1700 includes a wearable portion (e.g., wearable band 1710) and a removable structure (e.g., watch body 1720).

Turning to watch body 1720, in some examples watch body 1720 can have a substantially rectangular or circular shape. Watch body 1720 is configured to be worn by the user on their wrist or on another body part. More specifically, watch body 1720 is sized to be easily carried by the user, attached on a portion of the user's clothing, and/or coupled to wearable band 1710 (forming the wrist-wearable device 1700). As described above, watch body 1720 can have a shape corresponding to coupling mechanism 1716 of wearable band 1710. In some embodiments, watch body 1720 includes a single release mechanism 1729 or multiple release mechanisms (e.g., two release mechanisms 1729 positioned on opposing sides of watch body 1720, such as spring-loaded buttons) for decoupling watch body 1720 from wearable band 1710. Release mechanism 1729 can include, without limitation, a button, a knob, a plunger, a handle, a lever, a fastener, a clasp, a dial, a latch, or a combination thereof.

A user can actuate release mechanism 1729 by pushing, turning, lifting, depressing, shifting, or performing other actions on release mechanism 1729. Actuation of release mechanism 1729 can release (e.g., decouple) watch body 1720 from coupling mechanism 1716 of wearable band 1710, allowing the user to use watch body 1720 independently from wearable band 1710 and vice versa. For example, decoupling watch body 1720 from wearable band 1710 can allow a user to capture images using rear-facing camera 1725b. Although release mechanism 1729 is shown positioned at a corner of watch body 1720, release mechanism 1729 can be positioned anywhere on watch body 1720 that is convenient for the user to actuate. In addition, in some embodiments, wearable band 1710 can also include a respective release mechanism for decoupling watch body 1720 from coupling mechanism 1716. In some embodiments, release mechanism 1729 is optional and watch body 1720 can be decoupled from coupling mechanism 1716 as described above (e.g., via twisting, rotating, etc.).

Watch body 1720 can include one or more peripheral buttons 1723 and 1727 for performing various operations at watch body 1720. For example, peripheral buttons 1723 and 1727 can be used to turn on or wake (e.g., transition from a sleep state to an active state) display 1705, unlock watch body 1720, increase or decrease a volume, increase or decrease a brightness, interact with one or more applications, interact with one or more user interfaces, etc. Additionally or alternatively, in some embodiments, display 1705 operates as a touch screen and allows the user to provide one or more inputs for interacting with watch body 1720.

In some embodiments, watch body 1720 includes one or more sensors 1721. Sensors 1721 of watch body 1720 can be the same or distinct from sensors 1713 of wearable band 1710. Sensors 1721 of watch body 1720 can be distributed on an inside and/or an outside surface of watch body 1720. In some embodiments, sensors 1721 are configured to contact a user's skin when watch body 1720 is worn by the user. For example, sensors 1721 can be placed on the bottom side of watch body 1720 and coupling mechanism 1716 can be a cradle with an opening that allows the bottom side of watch body 1720 to directly contact the user's skin. Alternatively, in some embodiments, watch body 1720 does not include sensors that are configured to contact the user's skin (e.g., including sensors internal and/or external to the watch body 1720 that are configured to sense data of watch body 1720 and the surrounding environment). In some embodiments, sensors 1721 are configured to track a position and/or motion of watch body 1720.

Watch body 1720 and wearable band 1710 can share data using a wired communication method (e.g., a Universal Asynchronous Receiver/Transmitter (UART), a USB transceiver, etc.) and/or a wireless communication method (e.g., near field communication, Bluetooth, etc.). For example, watch body 1720 and wearable band 1710 can share data sensed by sensors 1713 and 1721, as well as application and device specific information (e.g., active and/or available applications, output devices (e.g., displays, speakers, etc.), input devices (e.g., touch screens, microphones, imaging sensors, etc.).

In some embodiments, watch body 1720 can include, without limitation, a front-facing camera 1725a and/or a rear-facing camera 1725b, sensors 1721 (e.g., a biometric sensor, an IMU, a heart rate sensor, a saturated oxygen sensor, a neuromuscular signal sensor, an altimeter sensor, a temperature sensor, a bioimpedance sensor, a pedometer sensor, an optical sensor (e.g., imaging sensor 1863), a touch sensor, a sweat sensor, etc.). In some embodiments, watch body 1720 can include one or more haptic devices 1876 (e.g., a vibratory haptic actuator) that is configured to provide haptic feedback (e.g., a cutaneous and/or kinesthetic sensation, etc.) to the user. Sensors 1821 and/or haptic device 1876 can also be configured to operate in conjunction with multiple applications including, without limitation, health monitoring applications, social media applications, game applications, and artificial reality applications (e.g., the applications associated with artificial reality).

As described above, watch body 1720 and wearable band 1710, when coupled, can form wrist-wearable device 1700. When coupled, watch body 1720 and wearable band 1710 may operate as a single device to execute functions (operations, detections, communications, etc.) described herein. In some embodiments, each device may be provided with particular instructions for performing the one or more operations of wrist-wearable device 1700. For example, in accordance with a determination that watch body 1720 does not include neuromuscular signal sensors, wearable band 1710 can include alternative instructions for performing associated instructions (e.g., providing sensed neuromuscular signal data to watch body 1720 via a different electronic device). Operations of wrist-wearable device 1700 can be performed by watch body 1720 alone or in conjunction with wearable band 1710 (e.g., via respective processors and/or hardware components) and vice versa. In some embodiments, operations of wrist-wearable device 1700, watch body 1720, and/or wearable band 1710 can be performed in conjunction with one or more processors and/or hardware components.

As described below with reference to the block diagram of FIG. 18, wearable band 1710 and/or watch body 1720 can each include independent resources required to independently execute functions. For example, wearable band 1710 and/or watch body 1720 can each include a power source (e.g., a battery), a memory, data storage, a processor (e.g., a central processing unit (CPU)), communications, a light source, and/or input/output devices.

FIG. 18 shows block diagrams of a computing system 1830 corresponding to wearable band 1710 and a computing system 1860 corresponding to watch body 1720 according to some embodiments. Computing system 1800 of wrist-wearable device 1700 may include a combination of components of wearable band computing system 1830 and watch body computing system 1860, in accordance with some embodiments.

Watch body 1720 and/or wearable band 1710 can include one or more components shown in watch body computing system 1860. In some embodiments, a single integrated circuit may include all or a substantial portion of the components of watch body computing system 1860 included in a single integrated circuit. Alternatively, in some embodiments, components of the watch body computing system 1860 may be included in a plurality of integrated circuits that are communicatively coupled. In some embodiments, watch body computing system 1860 may be configured to couple (e.g., via a wired or wireless connection) with wearable band computing system 1830, which may allow the computing systems to share components, distribute tasks, and/or perform other operations described herein (individually or as a single device).

Watch body computing system 1860 can include one or more processors 1879, a controller 1877, a peripherals interface 1861, a power system 1895, and memory (e.g., a memory 1880).

Power system 1895 can include a charger input 1896, a power-management integrated circuit (PMIC) 1897, and a battery 1898. In some embodiments, a watch body 1720 and a wearable band 1710 can have respective batteries (e.g., battery 1898 and 1859) and can share power with each other. Watch body 1720 and wearable band 1710 can receive a charge using a variety of techniques. In some embodiments, watch body 1720 and wearable band 1710 can use a wired charging assembly (e.g., power cords) to receive the charge. Alternatively, or in addition, watch body 1720 and/or wearable band 1710 can be configured for wireless charging. For example, a portable charging device can be designed to mate with a portion of watch body 1720 and/or wearable band 1710 and wirelessly deliver usable power to battery 1898 of watch body 1720 and/or battery 1859 of wearable band 1710. Watch body 1720 and wearable band 1710 can have independent power systems (e.g., power system 1895 and 1856, respectively) to enable each to operate independently. Watch body 1720 and wearable band 1710 can also share power (e.g., one can charge the other) via respective PMICs (e.g., PMICs 1897 and 1858) and charger inputs (e.g., 1857 and 1896) that can share power over power and ground conductors and/or over wireless charging antennas.

In some embodiments, peripherals interface 1861 can include one or more sensors 1821. Sensors 1821 can include one or more coupling sensors 1862 for detecting when watch body 1720 is coupled with another electronic device (e.g., a wearable band 1710). Sensors 1821 can include one or more imaging sensors 1863 (e.g., one or more of cameras 1825, and/or separate imaging sensors 1863 (e.g., thermal-imaging sensors)). In some embodiments, sensors 1821 can include one or more SpO2 sensors 1864. In some embodiments, sensors 1821 can include one or more biopotential-signal sensors (e.g., EMG sensors 1865, which may be disposed on an interior, user-facing portion of watch body 1720 and/or wearable band 1710). In some embodiments, sensors 1821 may include one or more capacitive sensors 1866. In some embodiments, sensors 1821 may include one or more heart rate sensors 1867. In some embodiments, sensors 1821 may include one or more IMU sensors 1868. In some embodiments, one or more IMU sensors 1868 can be configured to detect movement of a user's hand or other location where watch body 1720 is placed or held.

In some embodiments, one or more of sensors 1821 may provide an example human-machine interface. For example, a set of neuromuscular sensors, such as EMG sensors 1865, may be arranged circumferentially around wearable band 1710 with an interior surface of EMG sensors 1865 being configured to contact a user's skin. Any suitable number of neuromuscular sensors may be used (e.g., between 2 and 20 sensors). The number and arrangement of neuromuscular sensors may depend on the particular application for which the wearable device is used. For example, wearable band 1710 can be used to generate control information for controlling an augmented reality system, a robot, controlling a vehicle, scrolling through text, controlling a virtual avatar, or any other suitable control task.

In some embodiments, neuromuscular sensors may be coupled together using flexible electronics incorporated into the wireless device, and the output of one or more of the sensing components can be optionally processed using hardware signal processing circuitry (e.g., to perform amplification, filtering, and/or rectification). In other embodiments, at least some signal processing of the output of the sensing components can be performed in software such as processors 1879. Thus, signal processing of signals sampled by the sensors can be performed in hardware, software, or by any suitable combination of hardware and software, as aspects of the technology described herein are not limited in this respect.

Neuromuscular signals may be processed in a variety of ways. For example, the output of EMG sensors 1865 may be provided to an analog front end, which may be configured to perform analog processing (e.g., amplification, noise reduction, filtering, etc.) on the recorded signals. The processed analog signals may then be provided to an analog-to-digital converter, which may convert the analog signals to digital signals that can be processed by one or more computer processors. Furthermore, although this example is as discussed in the context of interfaces with EMG sensors, the embodiments described herein can also be implemented in wearable interfaces with other types of sensors including, but not limited to, mechanomyography (MMG) sensors, sonomyography (SMG) sensors, and electrical impedance tomography (EIT) sensors.

In some embodiments, peripherals interface 1861 includes a near-field communication (NFC) component 1869, a global-position system (GPS) component 1870, a long-term evolution (LTE) component 1871, and/or a Wi-Fi and/or Bluetooth communication component 1872. In some embodiments, peripherals interface 1861 includes one or more buttons 1873 (e.g., peripheral buttons 1723 and 1727 in FIG. 17), which, when selected by a user, cause operation to be performed at watch body 1720. In some embodiments, the peripherals interface 1861 includes one or more indicators, such as a light emitting diode (LED), to provide a user with visual indicators (e.g., message received, low battery, active microphone and/or camera, etc.).

Watch body 1720 can include at least one display 1705 for displaying visual representations of information or data to a user, including user-interface elements and/or three-dimensional virtual objects. The display can also include a touch screen for inputting user inputs, such as touch gestures, swipe gestures, and the like. Watch body 1720 can include at least one speaker 1874 and at least one microphone 1875 for providing audio signals to the user and receiving audio input from the user. The user can provide user inputs through microphone 1875 and can also receive audio output from speaker 1874 as part of a haptic event provided by haptic controller 1878. Watch body 1720 can include at least one camera 1825, including a front camera 1825a and a rear camera 1825b. Cameras 1825 can include ultra-wide-angle cameras, wide angle cameras, fish-eye cameras, spherical cameras, telephoto cameras, depth-sensing cameras, or other types of cameras.

Watch body computing system 1860 can include one or more haptic controllers 1878 and associated componentry (e.g., haptic devices 1876) for providing haptic events at watch body 1720 (e.g., a vibrating sensation or audio output in response to an event at the watch body 1720). Haptic controllers 1878 can communicate with one or more haptic devices 1876, such as electroacoustic devices, including a speaker of the one or more speakers 1874 and/or other audio components and/or electromechanical devices that convert energy into linear motion such as a motor, solenoid, electroactive polymer, piezoelectric actuator, electrostatic actuator, or other tactile output generating components (e.g., a component that converts electrical signals into tactile outputs on the device). Haptic controller 1878 can provide haptic events to that are capable of being sensed by a user of watch body 1720. In some embodiments, one or more haptic controllers 1878 can receive input signals from an application of applications 1882.

In some embodiments, wearable band computing system 1830 and/or watch body computing system 1860 can include memory 1880, which can be controlled by one or more memory controllers of controllers 1877. In some embodiments, software components stored in memory 1880 include one or more applications 1882 configured to perform operations at the watch body 1720. In some embodiments, one or more applications 1882 may include games, word processors, messaging applications, calling applications, web browsers, social media applications, media streaming applications, financial applications, calendars, clocks, etc. In some embodiments, software components stored in memory 1880 include one or more communication interface modules 1883 as defined above. In some embodiments, software components stored in memory 1880 include one or more graphics modules 1884 for rendering, encoding, and/or decoding audio and/or visual data and one or more data management modules 1885 for collecting, organizing, and/or providing access to data 1887 stored in memory 1880. In some embodiments, one or more of applications 1882 and/or one or more modules can work in conjunction with one another to perform various tasks at the watch body 1720.

In some embodiments, software components stored in memory 1880 can include one or more operating systems 1881 (e.g., a Linux-based operating system, an Android operating system, etc.). Memory 1880 can also include data 1887. Data 1887 can include profile data 1888A, sensor data 1889A, media content data 1890, and application data 1891.

It should be appreciated that watch body computing system 1860 is an example of a computing system within watch body 1720, and that watch body 1720 can have more or fewer components than shown in watch body computing system 1860, can combine two or more components, and/or can have a different configuration and/or arrangement of the components. The various components shown in watch body computing system 1860 are implemented in hardware, software, firmware, or a combination thereof, including one or more signal processing and/or application-specific integrated circuits.

Turning to the wearable band computing system 1830, one or more components that can be included in wearable band 1710 are shown. Wearable band computing system 1830 can include more or fewer components than shown in watch body computing system 1860, can combine two or more components, and/or can have a different configuration and/or arrangement of some or all of the components. In some embodiments, all, or a substantial portion of the components of wearable band computing system 1830 are included in a single integrated circuit. Alternatively, in some embodiments, components of wearable band computing system 1830 are included in a plurality of integrated circuits that are communicatively coupled. As described above, in some embodiments, wearable band computing system 1830 is configured to couple (e.g., via a wired or wireless connection) with watch body computing system 1860, which allows the computing systems to share components, distribute tasks, and/or perform other operations described herein (individually or as a single device).

Wearable band computing system 1830, similar to watch body computing system 1860, can include one or more processors 1849, one or more controllers 1847 (including one or more haptics controllers 1848), a peripherals interface 1831 that can includes one or more sensors 1813 and other peripheral devices, a power source (e.g., a power system 1856), and memory (e.g., a memory 1850) that includes an operating system (e.g., an operating system 1851), data (e.g., data 1854 including profile data 1888B, sensor data 1889B, etc.), and one or more modules (e.g., a communications interface module 1852, a data management module 1853, etc.).

One or more of sensors 1813 can be analogous to sensors 1821 of watch body computing system 1860. For example, sensors 1813 can include one or more coupling sensors 1832, one or more SpO2 sensors 1834, one or more EMG sensors 1835, one or more capacitive sensors 1836, one or more heart rate sensors 1837, and one or more IMU sensors 1838.

Peripherals interface 1831 can also include other components analogous to those included in peripherals interface 1861 of watch body computing system 1860, including an NFC component 1839, a GPS component 1840, an LTE component 1841, a Wi-Fi and/or Bluetooth communication component 1842, and/or one or more haptic devices 1846 as described above in reference to peripherals interface 1861. In some embodiments, peripherals interface 1831 includes one or more buttons 1843, a display 1833, a speaker 1844, a microphone 1845, and a camera 1855. In some embodiments, peripherals interface 1831 includes one or more indicators, such as an LED.

It should be appreciated that wearable band computing system 1830 is an example of a computing system within wearable band 1710, and that wearable band 1710 can have more or fewer components than shown in wearable band computing system 1830, combine two or more components, and/or have a different configuration and/or arrangement of the components. The various components shown in wearable band computing system 1830 can be implemented in one or more of a combination of hardware, software, or firmware, including one or more signal processing and/or application-specific integrated circuits.

Wrist-wearable device 1700 with respect to FIG. 17 is an example of wearable band 1710 and watch body 1720 coupled together, so wrist-wearable device 1700 will be understood to include the components shown and described for wearable band computing system 1830 and watch body computing system 1860. In some embodiments, wrist-wearable device 1700 has a split architecture (e.g., a split mechanical architecture, a split electrical architecture, etc.) between watch body 1720 and wearable band 1710. In other words, all of the components shown in wearable band computing system 1830 and watch body computing system 1860 can be housed or otherwise disposed in a combined wrist-wearable device 1700 or within individual components of watch body 1720, wearable band 1710, and/or portions thereof (e.g., a coupling mechanism 1716 of wearable band 1710).

The techniques described above can be used with any device for sensing neuromuscular signals but could also be used with other types of wearable devices for sensing neuromuscular signals (such as body-wearable or head-wearable devices that might have neuromuscular sensors closer to the brain or spinal column).

In some embodiments, wrist-wearable device 1700 can be used in conjunction with a head-wearable device (e.g., AR glasses 1900 and VR system 2010) and wrist-wearable device 1700 can also be configured to be used to allow a user to control any aspect of the artificial reality (e.g., by using EMG-based gestures to control user interface objects in the artificial reality and/or by allowing a user to interact with the touchscreen on the wrist-wearable device to also control aspects of the artificial reality). Having thus described example wrist-wearable devices, attention will now be turned to example head-wearable devices, such AR glasses 1900 and VR headset 2010.

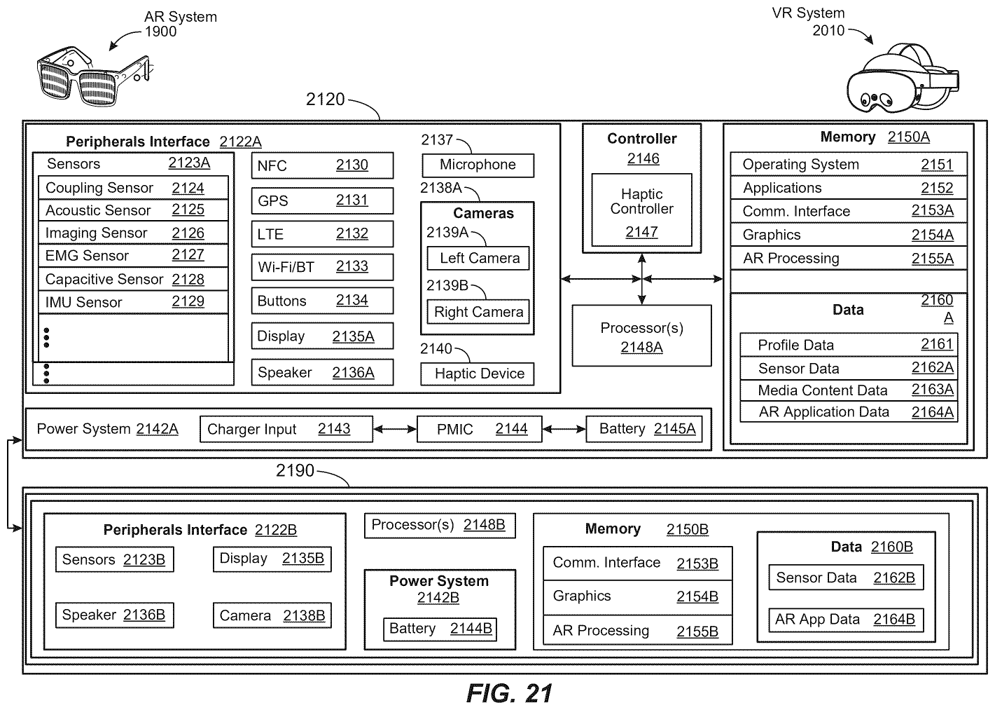

FIGS. 19 to 21 show example artificial-reality systems, which can be used as or in connection with wrist-wearable device 1700. In some embodiments, AR system 1900 includes an eyewear device 1902, as shown in FIG. 19. In some embodiments, VR system 2010 includes a head-mounted display (HMD) 2012, as shown in FIGS. 20A and 20B. In some embodiments, AR system 1900 and VR system 2010 can include one or more analogous components (e.g., components for presenting interactive artificial-reality environments, such as processors, memory, and/or presentation devices, including one or more displays and/or one or more waveguides), some of which are described in more detail with respect to FIG. 21. As described herein, a head-wearable device can include components of eyewear device 1902 and/or head-mounted display 2012. Some embodiments of head-wearable devices do not include any displays, including any of the displays described with respect to AR system 1900 and/or VR system 2010. While the example artificial-reality systems are respectively described herein as AR system 1900 and VR system 2010, either or both of the example AR systems described herein can be configured to present fully-immersive virtual-reality scenes presented in substantially all of a user's field of view or subtler augmented-reality scenes that are presented within a portion, less than all, of the user's field of view.

FIG. 19 show an example visual depiction of AR system 1900, including an eyewear device 1902 (which may also be described herein as augmented-reality glasses, and/or smart glasses). AR system 1900 can include additional electronic components that are not shown in FIG. 19, such as a wearable accessory device and/or an intermediary processing device, in electronic communication or otherwise configured to be used in conjunction with the eyewear device 1902. In some embodiments, the wearable accessory device and/or the intermediary processing device may be configured to couple with eyewear device 1902 via a coupling mechanism in electronic communication with a coupling sensor 2124 (FIG. 21), where coupling sensor 2124 can detect when an electronic device becomes physically or electronically coupled with eyewear device 1902. In some embodiments, eyewear device 1902 can be configured to couple to a housing 2190 (FIG. 21), which may include one or more additional coupling mechanisms configured to couple with additional accessory devices. The components shown in FIG. 19 can be implemented in hardware, software, firmware, or a combination thereof, including one or more signal-processing components and/or application-specific integrated circuits (ASICs).

Eyewear device 1902 includes mechanical glasses components, including a frame 1904 configured to hold one or more lenses (e.g., one or both lenses 1906-1 and 1906-2). One of ordinary skill in the art will appreciate that eyewear device 1902 can include additional mechanical components, such as hinges configured to allow portions of frame 1904 of eyewear device 1902 to be folded and unfolded, a bridge configured to span the gap between lenses 1906-1 and 1906-2 and rest on the user's nose, nose pads configured to rest on the bridge of the nose and provide support for eyewear device 1902, earpieces configured to rest on the user's ears and provide additional support for eyewear device 1902, temple arms configured to extend from the hinges to the earpieces of eyewear device 1902, and the like. One of ordinary skill in the art will further appreciate that some examples of AR system 1900 can include none of the mechanical components described herein. For example, smart contact lenses configured to present artificial reality to users may not include any components of eyewear device 1902.

Eyewear device 1902 includes electronic components, many of which will be described in more detail below with respect to FIG. 10. Some example electronic components are illustrated in FIG. 19, including acoustic sensors 1925-1, 1925-2, 1925-3, 1925-4, 1925-5, and 1925-6, which can be distributed along a substantial portion of the frame 1904 of eyewear device 1902. Eyewear device 1902 also includes a left camera 1939A and a right camera 1939B, which are located on different sides of the frame 1904. Eyewear device 1902 also includes a processor 1948 (or any other suitable type or form of integrated circuit) that is embedded into a portion of the frame 1904.

FIGS. 20A and 20B show a VR system 2010 that includes a head-mounted display (HMD) 2012 (e.g., also referred to herein as an artificial-reality headset, a head-wearable device, a VR headset, etc.), in accordance with some embodiments. As noted, some artificial-reality systems (e.g., AR system 1900) may, instead of blending an artificial reality with actual reality, substantially replace one or more of a user's visual and/or other sensory perceptions of the real world with a virtual experience (e.g., AR systems 1500 and 1600).

HMD 2012 includes a front body 2014 and a frame 2016 (e.g., a strap or band) shaped to fit around a user's head. In some embodiments, front body 2014 and/or frame 2016 include one or more electronic elements for facilitating presentation of and/or interactions with an AR and/or VR system (e.g., displays, IMUs, tracking emitter or detectors). In some embodiments, HMD 2012 includes output audio transducers (e.g., an audio transducer 2018), as shown in FIG. 20B. In some embodiments, one or more components, such as the output audio transducer(s) 2018 and frame 2016, can be configured to attach and detach (e.g., are detachably attachable) to HMD 2012 (e.g., a portion or all of frame 2016, and/or audio transducer 2018), as shown in FIG. 20B. In some embodiments, coupling a detachable component to HMD 2012 causes the detachable component to come into electronic communication with HMD 2012.

FIGS. 20A and 20B also show that VR system 2010 includes one or more cameras, such as left camera 2039A and right camera 2039B, which can be analogous to left and right cameras 1939A and 1939B on frame 1904 of eyewear device 1902. In some embodiments, VR system 2010 includes one or more additional cameras (e.g., cameras 2039C and 2039D), which can be configured to augment image data obtained by left and right cameras 2039A and 2039B by providing more information. For example, camera 2039C can be used to supply color information that is not discerned by cameras 2039A and 2039B. In some embodiments, one or more of cameras 2039A to 2039D can include an optional IR cut filter configured to remove IR light from being received at the respective camera sensors.

FIG. 21 illustrates a computing system 2120 and an optional housing 2190, each of which show components that can be included in AR system 1900 and/or VR system 2010. In some embodiments, more or fewer components can be included in optional housing 2190 depending on practical restraints of the respective AR system being described.

In some embodiments, computing system 2120 can include one or more peripherals interfaces 2122A and/or optional housing 2190 can include one or more peripherals interfaces 2122B. Each of computing system 2120 and optional housing 2190 can also include one or more power systems 2142A and 2142B, one or more controllers 2146 (including one or more haptic controllers 2147), one or more processors 2148A and 2148B (as defined above, including any of the examples provided), and memory 2150A and 2150B, which can all be in electronic communication with each other. For example, the one or more processors 2148A and 2148B can be configured to execute instructions stored in memory 2150A and 2150B, which can cause a controller of one or more of controllers 2146 to cause operations to be performed at one or more peripheral devices connected to peripherals interface 2122A and/or 2122B. In some embodiments, each operation described can be powered by electrical power provided by power system 2142A and/or 2142B.

In some embodiments, peripherals interface 2122A can include one or more devices configured to be part of computing system 2120, some of which have been defined above and/or described with respect to the wrist-wearable devices shown in FIGS. 17 and 18. For example, peripherals interface 2122A can include one or more sensors 2123A. Some example sensors 2123A include one or more coupling sensors 2124, one or more acoustic sensors 2125, one or more imaging sensors 2126, one or more EMG sensors 2127, one or more capacitive sensors 2128, one or more IMU sensors 2129, and/or any other types of sensors explained above or described with respect to any other embodiments discussed herein.

In some embodiments, peripherals interfaces 2122A and 2122B can include one or more additional peripheral devices, including one or more NFC devices 2130, one or more GPS devices 2131, one or more LTE devices 2132, one or more Wi-Fi and/or Bluetooth devices 2133, one or more buttons 2134 (e.g., including buttons that are slidable or otherwise adjustable), one or more displays 2135A and 2135B, one or more speakers 2136A and 2136B, one or more microphones 2137, one or more cameras 2138A and 2138B (e.g., including the left camera 2139A and/or a right camera 2139B), one or more haptic devices 2140, and/or any other types of peripheral devices defined above or described with respect to any other embodiments discussed herein.

AR systems can include a variety of types of visual feedback mechanisms (e.g., presentation devices). For example, display devices in AR system 1900 and/or VR system 2010 can include one or more liquid-crystal displays (LCDs), light emitting diode (LED) displays, organic LED (OLED) displays, and/or any other suitable types of display screens. Artificial-reality systems can include a single display screen (e.g., configured to be seen by both eyes), and/or can provide separate display screens for each eye, which can allow for additional flexibility for varifocal adjustments and/or for correcting a refractive error associated with a user's vision. Some embodiments of AR systems also include optical subsystems having one or more lenses (e.g., conventional concave or convex lenses, Fresnel lenses, or adjustable liquid lenses) through which a user can view a display screen.

For example, respective displays 2135A and 2135B can be coupled to each of the lenses 1906-1 and 1906-2 of AR system 1900. Displays 2135A and 2135B may be coupled to each of lenses 1906-1 and 1906-2, which can act together or independently to present an image or series of images to a user. In some embodiments, AR system 1900 includes a single display 2135A or 2135B (e.g., a near-eye display) or more than two displays 2135A and 2135B. In some embodiments, a first set of one or more displays 2135A and 2135B can be used to present an augmented-reality environment, and a second set of one or more display devices 2135A and 2135B can be used to present a virtual-reality environment. In some embodiments, one or more waveguides are used in conjunction with presenting artificial-reality content to the user of AR system 1900 (e.g., as a means of delivering light from one or more displays 2135A and 2135B to the user's eyes). In some embodiments, one or more waveguides are fully or partially integrated into the eyewear device 1902. Additionally, or alternatively to display screens, some artificial-reality systems include one or more projection systems. For example, display devices in AR system 1900 and/or VR system 2010 can include micro-LED projectors that project light (e.g., using a waveguide) into display devices, such as clear combiner lenses that allow ambient light to pass through. The display devices can refract the projected light toward a user's pupil and can enable a user to simultaneously view both artificial-reality content and the real world. Artificial-reality systems can also be configured with any other suitable type or form of image projection system. In some embodiments, one or more waveguides are provided additionally or alternatively to the one or more display(s) 2135A and 2135B.

Computing system 2120 and/or optional housing 2190 of AR system 1900 or VR system 2010 can include some or all of the components of a power system 2142A and 2142B. Power systems 2142A and 2142B can include one or more charger inputs 2143, one or more PMICs 2144, and/or one or more batteries 2145A and 2144B.

Memory 2150A and 2150B may include instructions and data, some or all of which may be stored as non-transitory computer-readable storage media within the memories 2150A and 2150B. For example, memory 2150A and 2150B can include one or more operating systems 2151, one or more applications 2152, one or more communication interface applications 2153A and 2153B, one or more graphics applications 2154A and 2154B, one or more AR processing applications 2155A and 2155B, and/or any other types of data defined above or described with respect to any other embodiments discussed herein.

Memory 2150A and 2150B also include data 2160A and 2160B, which can be used in conjunction with one or more of the applications discussed above. Data 2160A and 2160B can include profile data 2161, sensor data 2162A and 2162B, media content data 2163A, AR application data 2164A and 2164B, and/or any other types of data defined above or described with respect to any other embodiments discussed herein.

In some embodiments, controller 2146 of eyewear device 1902 may process information generated by sensors 2123A and/or 2123B on eyewear device 1902 and/or another electronic device within AR system 1900. For example, controller 2146 can process information from acoustic sensors 1925-1 and 1925-2. For each detected sound, controller 2146 can perform a direction of arrival (DOA) estimation to estimate a direction from which the detected sound arrived at eyewear device 1902 of R system 1900. As one or more of acoustic sensors 2125 (e.g., the acoustic sensors 1925-1, 1925-2) detects sounds, controller 2146 can populate an audio data set with the information (e.g., represented in FIG. 10 as sensor data 2162A and 2162B).

In some embodiments, a physical electronic connector can convey information between eyewear device 1902 and another electronic device and/or between one or more processors 1948, 2148A, 2148B of AR system 1900 or VR system 2010 and controller 2146. The information can be in the form of optical data, electrical data, wireless data, or any other transmittable data form. Moving the processing of information generated by eyewear device 1902 to an intermediary processing device can reduce weight and heat in the eyewear device, making it more comfortable and safer for a user. In some embodiments, an optional wearable accessory device (e.g., an electronic neckband) is coupled to eyewear device 1902 via one or more connectors. The connectors can be wired or wireless connectors and can include electrical and/or non-electrical (e.g., structural) components. In some embodiments, eyewear device 1902 and the wearable accessory device can operate independently without any wired or wireless connection between them.

In some situations, pairing external devices, such as an intermediary processing device (e.g., HIPD 1306, 1406, 1506) with eyewear device 1902 (e.g., as part of AR system 1900) enables eyewear device 1902 to achieve a similar form factor of a pair of glasses while still providing sufficient battery and computation power for expanded capabilities. Some, or all, of the battery power, computational resources, and/or additional features of AR system 1900 can be provided by a paired device or shared between a paired device and eyewear device 1902, thus reducing the weight, heat profile, and form factor of eyewear device 1902 overall while allowing eyewear device 1902 to retain its desired functionality. For example, the wearable accessory device can allow components that would otherwise be included on eyewear device 1902 to be included in the wearable accessory device and/or intermediary processing device, thereby shifting a weight load from the user's head and neck to one or more other portions of the user's body. In some embodiments, the intermediary processing device has a larger surface area over which to diffuse and disperse heat to the ambient environment. Thus, the intermediary processing device can allow for greater battery and computation capacity than might otherwise have been possible on eyewear device 1902 standing alone. Because weight carried in the wearable accessory device can be less invasive to a user than weight carried in the eyewear device 1902, a user may tolerate wearing a lighter eyewear device and carrying or wearing the paired device for greater lengths of time than the user would tolerate wearing a heavier eyewear device standing alone, thereby enabling an artificial-reality environment to be incorporated more fully into a user's day-to-day activities.

AR systems can include various types of computer vision components and subsystems. For example, AR system 1900 and/or VR system 2010 can include one or more optical sensors such as two-dimensional (2D) or three-dimensional (3D) cameras, time-of-flight depth sensors, structured light transmitters and detectors, single-beam or sweeping laser rangefinders, 3D LiDAR sensors, and/or any other suitable type or form of optical sensor. An AR system can process data from one or more of these sensors to identify a location of a user and/or aspects of the use's real-world physical surroundings, including the locations of real-world objects within the real-world physical surroundings. In some embodiments, the methods described herein are used to map the real world, to provide a user with context about real-world surroundings, and/or to generate digital twins (e.g., interactable virtual objects), among a variety of other functions. For example, FIGS. 20A and 20B show VR system 2010 having cameras 2039A to 2039D, which can be used to provide depth information for creating a voxel field and a two-dimensional mesh to provide object information to the user to avoid collisions.

In some embodiments, AR system 1900 and/or VR system 2010 can include haptic (tactile) feedback systems, which may be incorporated into headwear, gloves, body suits, handheld controllers, environmental devices (e.g., chairs or floormats), and/or any other type of device or system, such as the wearable devices discussed herein. The haptic feedback systems may provide various types of cutaneous feedback, including vibration, force, traction, shear, texture, and/or temperature. The haptic feedback systems may also provide various types of kinesthetic feedback, such as motion and compliance. The haptic feedback may be implemented using motors, piezoelectric actuators, fluidic systems, and/or a variety of other types of feedback mechanisms. The haptic feedback systems may be implemented independently of other artificial-reality devices, within other artificial-reality devices, and/or in conjunction with other artificial-reality devices.

In some embodiments of an artificial reality system, such as AR system 1900 and/or VR system 2010, ambient light (e.g., a live feed of the surrounding environment that a user would normally see) can be passed through a display element of a respective head-wearable device presenting aspects of the AR system. In some embodiments, ambient light can be passed through a portion less that is less than all of an AR environment presented within a user's field of view (e.g., a portion of the AR environment co-located with a physical object in the user's real-world environment that is within a designated boundary (e.g., a guardian boundary) configured to be used by the user while they are interacting with the AR environment). For example, a visual user interface element (e.g., a notification user interface element) can be presented at the head-wearable device, and an amount of ambient light (e.g., 15-50% of the ambient light) can be passed through the user interface element such that the user can distinguish at least a portion of the physical environment over which the user interface element is being displayed.

### Example Embodiments

Example 5: A method including (1) sorting visual content within a three-dimensional (3D) scene in a rendering order by: for each set of two-dimensional (2D) elements within a same virtual plane: creating a boundary around the 2D elements; using the boundary to set the rendering order of each element with the set of 2D elements; and rendering the visual content based on the rendering order.

Example 6: The method of example 5, where sorting the visual content in the rendering order further includes, for each set of 2D elements, prioritizing non-transparent 3D elements among other 3D elements and 2D elements within the three-dimensional scene.

Example 7: The method of claim 5, where sorting the visual content in the rendering order further includes, for each set of 2D elements, projecting the boundary where the visual content will be rendered into a screen space.

Example 8: The method of claim 5, where using the boundary to set the rendering order of each element with the set of 2D elements further includes comparing a depth of the boundary around the 2D elements with one or more depths of other boundaries.

Example 9: The method of claim 8, where using the boundary to set the rendering order of each element with the set of 2D elements further includes comparing the depth of the boundary around the 2D elements with the one or more depths of the other boundaries around 3D elements.

Example 10: The method of claim 8, where using the boundary to set the rendering order of each element with the set of 2D elements further includes comparing the depth of the boundary around 3D elements with the one or more depths of the other boundaries around the 3D elements.

Example 11: The method of claim 5, where rendering the visual content within the same virtual plane further includes enabling a user to apply selective control over the rendering order in which the 2D elements will be rendered.

What is claimed is:

1. A method comprising:
sensing a temperature value of a battery circuit;
activating a heat dissipation element within the battery circuit when the temperature value reaches a threshold;
discharging heat from the battery circuit via the activated heat dissipation element; and
deactivating the heat dissipation element when the temperature value falls below the threshold.

2. A head-mounted display comprising:
a display unit configured to display computer-generated imagery to a user; and
a housing that retains the display unit;
wherein, when the head-mounted display is mounted on a head of the user and the display unit is positioned in a top portion of a field of view of the user:
the display unit obstructs the top portion of the field of view of the user; and
the housing is dimensioned to provide the user with a substantially unobstructed bottom portion of the field of view of a real-world environment to the user.

3. A computer-implemented method of augmenting image data, the method comprising:
retrieving a subset of image data from a private database in response to a user input;
privatizing the subset of image data; and
generating at least one image based on the privatized subset of image data and the user input.

4. A method comprising:
reconstructing a geometry of a scene into sub-elements using depth information stored in a depth buffer;
specifying at least one parameter to selectively generate the sub-elements; and
accelerating the sub-element generation using a tile based renderer.

5. A method comprising:
sorting visual content within a three-dimensional (3D) scene in a rendering order by:
for each set of two-dimensional (2D) elements within a same virtual plane:
creating a boundary around the 2D elements;
using the boundary to set the rendering order of each element with the set of 2D elements; and
rendering the visual content based on the rendering order.

6. The method of claim 5, wherein sorting the visual content in the rendering order further comprises, for each set of 2D elements, prioritizing non-transparent 3D elements among other 3D elements and 2D elements within the three-dimensional scene.

7. The method of claim 5, wherein sorting the visual content in the rendering order further comprises, for each set of 2D elements, projecting the boundary where the visual content will be rendered into a screen space.

8. The method of claim 5, wherein using the boundary to set the rendering order of each element with the set of 2D elements further comprises comparing a depth of the boundary around the 2D elements with one or more depths of other boundaries.

9. The method of claim 8, wherein using the boundary to set the rendering order of each element with the set of 2D elements further comprises comparing the depth of the boundary around the 2D elements with the one or more depths of the other boundaries around 3D elements.

10. The method of claim 8, wherein using the boundary to set the rendering order of each element with the set of 2D elements further comprises comparing the depth of the boundary around 3D elements with the one or more depths of the other boundaries around the 3D elements.

11. The method of claim 5, wherein rendering the visual content within the same virtual plane further comprises enabling a user to apply selective control over the rendering order in which the 2D elements will be rendered.
